(19) United States
(12) Patent Application Publication
(10) Pub. No.: US 2025/0291525 A1
(43) Pub. Date: Sep. 18, 2025

(54) STORAGE MEDIUM STORING APPLICATION PROGRAM THAT ALLOWS TO SET READING CONDITION SUCH AS READING SIZE FOR IMAGE TO BE READ BY IMAGE PROCESSING APPARATUS, CONTROL METHOD, AND INFORMATION PROCESSING APPARATUS

(71) Applicant: CANON KABUSHIKI KAISHA, Tokyo (JP)

(72) Inventor: TAKU SHINOHARA, Saitama (JP)

(21) Appl. No.: 19/080,841

(22) Filed: Mar. 15, 2025

(30) Foreign Application Priority Data
Mar. 18, 2024 (JP) 2024-042612

(51) Int. Cl. G06F 3/12

(52) U.S. Cl. CPC G06F 3/1205; G06F 3/1222; G06F 3/1256; G06F 3/1258

(57) ABSTRACT

A mechanism a reading condition in a case of using a software program that can be commonly used for image processing apparatuses from a plurality of manufacturers is provided. A non-transitory computer-readable storage medium storing an application program that supports a software program capable of being commonly used for image processing apparatuses from a plurality of manufacturers for causing a computer to execute a display control step of causing to display a setting acceptance screen that accepts a setting of a reading condition for an image to be read by the image processing apparatus, and a reading step of causing the image processing apparatus to read the image based on the reading condition that has been accepted on the setting acceptance screen.

### BACKGROUND OF THE INVENTION

### Field of the Invention

The present invention relates to a storage medium storing an application program, a control method, and an information processing apparatus.

### Description of the Related Art

A host computer (an information processing apparatus) capable of processing information to and from a scan apparatus is communicably connected to the scan apparatus (a scanner) that performs image reading, that is, performs scanning. As control software for controlling the scan apparatus, for example, a scan driver installed from the scan apparatus into the host computer is used. This scan driver allows the host computer to issue a scan instruction to the scan apparatus. An operating system (hereinafter, referred to as “an OS”), which is basic software, has been installed in advance into the host computer. The scan driver is configured in accordance with the specifications defined by the OS, and is able to operate by being called out from the OS. In addition, such scan drivers differ depending on vendors that supply scan apparatuses, that is, the scan drivers are model-specific scan drivers suitable for each scan apparatus.

In recent years, Windows (registered trademark) has been trying to provide a standard class driver (hereinafter, sometimes referred to as “a standard driver”) that can be used in common even for scan apparatuses supplied by a plurality of different vendors. Such a standard driver has been built into the OS in advance. Furthermore, it is possible to use the standard driver by connecting any scan apparatus to the host computer having the OS, into which the standard driver has been built. As a result, it is possible to omit installing the model-specific scan driver. In addition, the standard driver is assumed to be configured to be capable of designating a scan function included in the scan apparatus in accordance with scan function information generated based on information obtained from the scan apparatus. As a result, it is possible to designate the scan function for each scan apparatus by using one standard driver.

Since the standard driver is capable of being commonly used for the scan apparatuses supplied by the plurality of different vendors, for example, it may become impossible for the standard driver to cause a scan apparatus supplied by a predetermined vendor to execute some of the functions included in the scan apparatus supplied by the predetermined vendor. Japanese Laid-Open Patent Publication (kokai) No. 2021-033526 discloses a program that extends print functions of a print service that can be used universally regardless of the model or vendor of an image forming apparatus. As a result, by operating a print setting screen tailored to an individual image forming apparatus for each model or vendor, it is possible to cause to execute print functions that cannot be executed only by the print service that can be used universally.

However, with the standard driver, even if one wishes to perform setting of a reading condition such as a reading size for an image to be scanned by the scan apparatus, it is not possible to perform the setting of the reading condition such as the reading size.

### SUMMARY OF THE INVENTION

The present invention provides a mechanism a reading condition in a case of using a software program that can be commonly used for image processing apparatuses from a plurality of manufacturers.

Accordingly, the present invention provides a non-transitory computer-readable storage medium storing an application program that supports a software program capable of being commonly used for image processing apparatuses from a plurality of manufacturers for causing a computer to execute a display control step of causing to display a setting acceptance screen that accepts a setting of a reading condition for an image to be read by the image processing apparatus, and a reading step of causing the image processing apparatus to read the image based on the reading condition that has been accepted on the setting acceptance screen.

According to the present invention, in the case of using the software program that can be commonly used for the image processing apparatuses from the plurality of manufacturers, it is possible to set the reading condition.

Further features of the present invention will become apparent from the following description of exemplary embodiments with reference to the attached drawings.

### BRIEF DESCRIPTION OF THE DRAWINGS

FIG. 1 is a block diagram that shows a hardware configuration of a scan system according to a first embodiment.

FIG. 2A and FIG. 2B are block diagrams that show software configurations of the scan system.

FIGS. 3A, 3B, and 3C are diagrams that show examples of screens displayed on a display unit of the scan system.

FIG. 4 is a flowchart that shows a processing in which a scan function extending unit edits scan function information.

FIGS. 5A, 5B, and 5C are diagrams that show examples of a list table of scan information.

FIG. 6 is a sequence diagram that shows processes executed between a scan application, general purpose scan software, an extended application, and a scan apparatus after the scan application accepts a scan setting.

FIG. 7 is a flowchart that shows a processing executed by the extended application.

FIG. 8 is a flowchart that shows a processing executed by the scan apparatus.

FIG. 9 is a flowchart that shows a processing in which the scan function extending unit edits the scan function information in a second embodiment.

FIG. 10 is a diagram that show an example of the screen displayed on the display unit of the scan system.

FIG. 11 is a sequence diagram that shows processes executed between the scan application, the general purpose scan software, the extended application, and the scan apparatus after the scan application accepts a scan setting.

FIG. 12 is a flowchart that shows a processing executed by the extended application.

FIGS. 13A and 13B are diagrams relating to the scan information in a third embodiment.

FIG. 14 is a flowchart that shows a processing in which the scan function extending unit edits the scan function information.

FIGS. 15A, 15B, and 15C are diagrams relating to the scan information (a modification).

FIG. 16 is a flowchart that shows a processing executed by the extended application.

FIGS. 17A, 17B, 17C, and 17D are diagrams relating to the scan information in a fourth embodiment.

FIGS. 18A and 18B are diagrams relating to the scan information (a first modification).

FIGS. 19A, 19B, and 19C are diagrams relating to the scan information (a second modification).

FIGS. 20A, 20B, and 20C are diagrams relating to the scan information in a fifth embodiment.

FIG. 21 is a flowchart that shows a processing in which the scan function extending unit edits the scan function information.

FIG. 22 is a flowchart that shows a processing executed by the extended application.

FIGS. 23A, 23B, and 23C are diagrams relating to the scan information in a sixth embodiment.

FIGS. 24A, 24B, 24C, and 24D are diagrams relating to the scan information in a seventh embodiment.

FIGS. 25A, 25B, and 25C are diagrams that show examples of the screens displayed on the display unit of the scan system in an eighth embodiment.

### DESCRIPTION OF THE EMBODIMENTS

The present invention will now be described in detail below with reference to the accompanying drawings showing embodiments thereof.

Hereinafter, each embodiment of the present invention will be described in detail with reference to the drawings. However, the configuration described in each embodiment below is merely an example, and the scope of the present invention is not limited by the configuration described in each embodiment. For example, each unit (each component) constituting the present invention can be replaced with a unit (a component) with any configuration that can perform the same function(s). In addition, any component(s) may be added. Furthermore, any two or more configurations (features) of each embodiment can be combined.

### First Embodiment

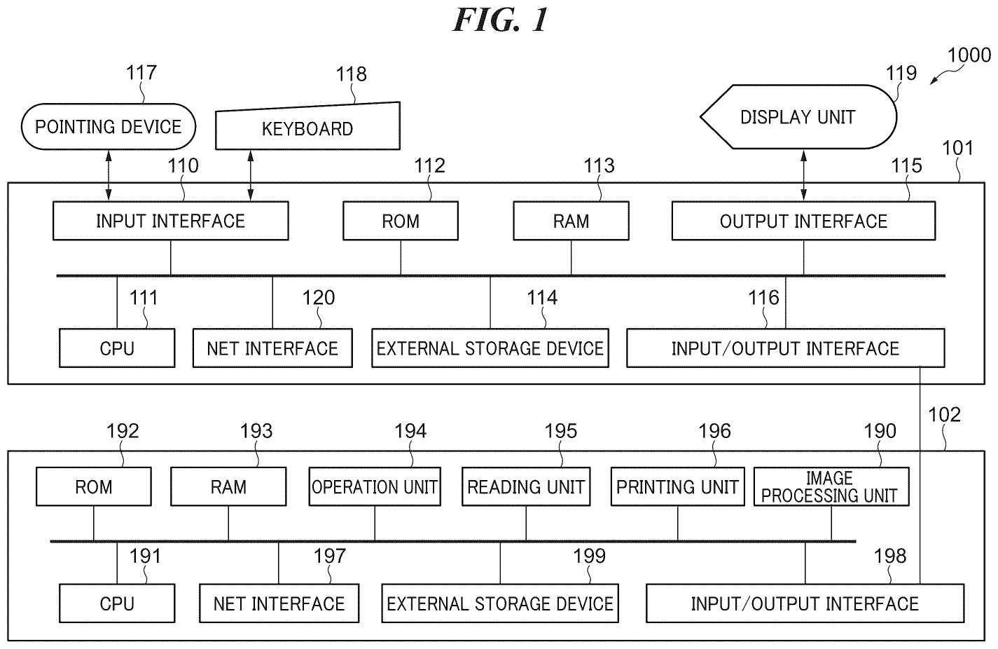

A first embodiment of the present invention will be described below with reference to FIGS. 1 to 8.

### <Hardware Configuration of Scan System>

FIG. 1 is a block diagram that shows a hardware configuration of a scan system according to the first embodiment. As shown in FIG. 1, a scan system 1000 includes a host computer 101, a scan apparatus (a scanner) 102 which is an example of an image processing apparatus, a pointing device 117, a keyboard 118, and a display unit 119, and the host computer 101, the scan apparatus 102, the pointing device 117, the keyboard 118, and the display unit 119 are communicably connected to each other. The host computer 101 is an information processing apparatus, and includes an input interface 110, a central processing unit (a CPU) 111, a read only memory (a ROM) 112, a random access memory (a RAM) 113, an external storage device (a storage medium) 114, an output interface 115, an input/output interface 116, and a NET interface 120. It should be noted that the host computer 101 may be, for example, a desktop type personal computer, but is not limited to this, and for example, may be a notebook type personal computer, a tablet terminal, a smartphone, or the like.

The CPU 111 is a computer that executes programs and the like that have been stored in the ROM 112 and the external storage device 114. It should be noted that in the first embodiment, the CPU 111 is able to execute the functions and processes of the host computer 101 by performing processing in accordance with codes of the programs that have been stored in the ROM 112. The ROM 112 stores an initialization program. The external storage device 114 stores an application program group (a group of application programs), an operating system (an OS), print data generation software, and other various kinds of data. It should be noted that in the first embodiment, Windows (registered trademark) 11 by Microsoft (registered trademark) has been installed into the host computer 101 as the OS. The external storage device 114 is not particularly limited, and may be, for example, a hard disk drive (an HDD) or a solid state drive (an SSD). The RAM 113 is used as a working memory or the like when executing various kinds of programs stored in the external storage device 114, and the various kinds of programs become able to run within the host computer 101. The pointing device 117 and the keyboard 118, which are input devices, are connected to the input interface 110. The display unit 119, which is a display device, is connected to the output interface 115. The display unit 119 displays, for example, a scan setting screen 300A and a detailed setting screen 300C, which will be described below. The NET interface 120 is a network interface, and performs control for performing data transfer with an external device (not shown) via a network (not shown). The scan apparatus 102 is connected to the input/output interface 116. As a result, the host computer 101 becomes capable of communicating with scan apparatuses 102 from a plurality of manufacturers, regardless of the manufacturer of the scan apparatus 102, that is, becomes capable of processing information to and from the scan apparatuses 102 from the plurality of manufacturers. The host computer 101 and the scan apparatus 102 may be connected to each other by wire or wirelessly.

The scan apparatus 102 includes an image processing unit 190, a CPU 191, a ROM 192, a RAM 193, an operation unit 194, a reading unit 195, a printing unit 196, a NET interface 197, an input/output interface 198, and an external storage device 199. The CPU 191 is a computer that executes programs and the like that have been stored in the ROM 192 and the external storage device 199, and comprehensively controls the scan apparatus 102. The ROM 192 is a memory that stores programs. The RAM 193 is a memory that temporarily stores programs and image data. The operation unit 194 allows various kinds of operation instructions to be given to the scan apparatus 102. The reading unit 195 reads an image of a document. The printing unit 196 prints an image on a sheet based on image data generated by, for example, reading an image of a document by the reading unit 195. The NET interface 197 is a network interface, and performs control for performing data transfer with an external device (not shown) via the network (not shown). The host computer 101 is connected to the input/output interface 198. The image data generated by, for example, reading an image of a document by the reading unit 195 is inputted into the image processing unit 190. In addition, the image processing unit 190 performs various kinds of editing processes on the image data.

The scan apparatus 102 is not particularly limited as long as it is an image processing apparatus having an image reading function, i.e., a scan function, and may be, for example, a multifunction peripheral (an MFP) or the like. In addition, in the case of using a multifunction peripheral as the scan apparatus 102, the printing performed by the multifunction peripheral is electrophotographic printing in the first embodiment, but is not limited to this and can also be, for example, inkjet printing or the like. In addition, in the first embodiment, the host computer 101 and the scan apparatus 102 are configured as separate apparatuses, but the present invention is not limited to this. For example, the host computer 101 and the scan apparatus 102 may be configured as an integrated apparatus.

### <Configuration of Scan System Centered on Software>

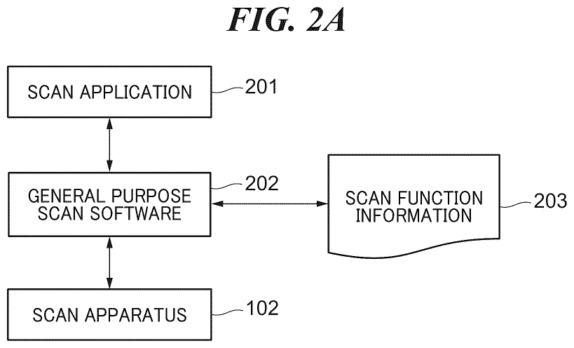

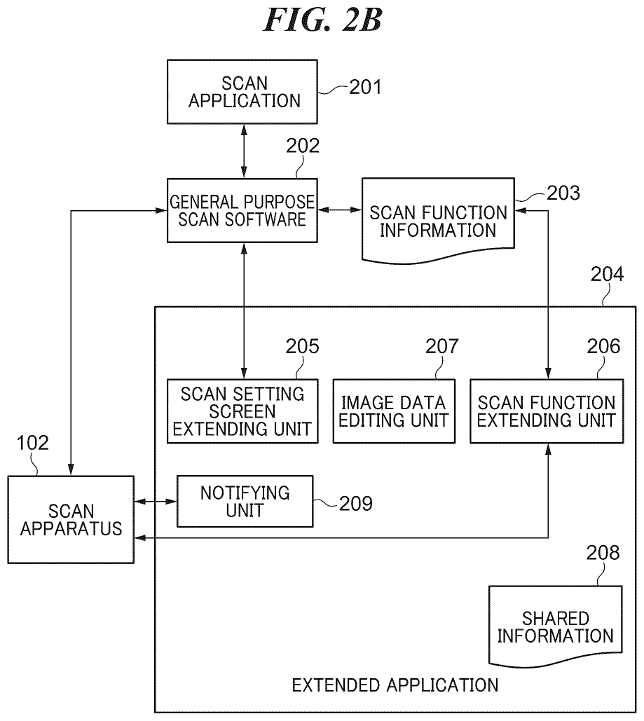

FIG. 2A and FIG. 2B are block diagrams that show software configurations of the scan system. FIG. 2A is a diagram that shows a general configuration in the case where an extended application (an application program) 204 has not been associated with general purpose scan software (a software program) 202 and the scan apparatus 102. Furthermore, FIG. 2B is a diagram that shows a configuration in the case where the extended application 204 has been associated with the general purpose scan software 202 and the scan apparatus 102.

The general purpose scan software 202 is a general purpose program that is capable of being used, for example, when performing scanning (when performing image reading) in common with respect to the scan apparatuses 102 from the plurality of manufacturers, and has been installed into the OS in advance. The extended application 204 is a program that supports the general purpose scan software 202, that is, assists the general purpose scan software 202. In the first embodiment, the extended application 204 is an extended program (a program that executes a control method) that is capable of extending functions that cannot be executed by the general purpose scan software 202 with respect to the scan apparatus 102, but is not limited to this. For example, the extended application 204 may be a program that improves the convenience of functions that can be executed by the general purpose scan software 202 with respect to the scan apparatus 102. The extended application 204 has been stored in the external storage device 114 together with, for example, the OS (the general purpose scan software 202). As a result, it becomes possible for the host computer 101 to include the general purpose scan software 202 and the extended application 204.

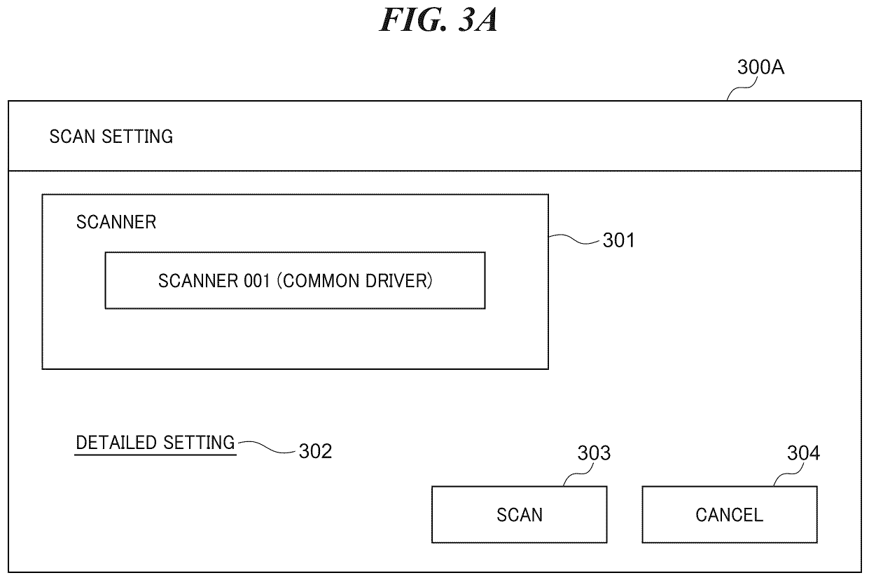

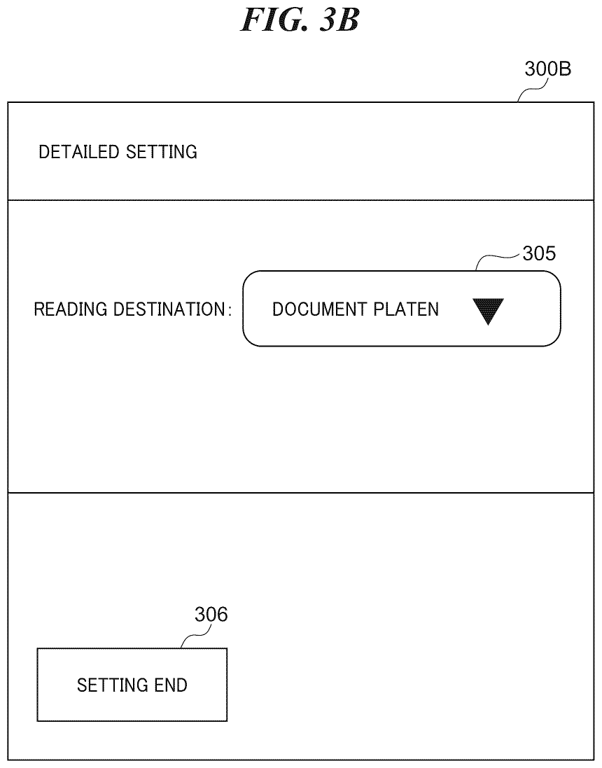

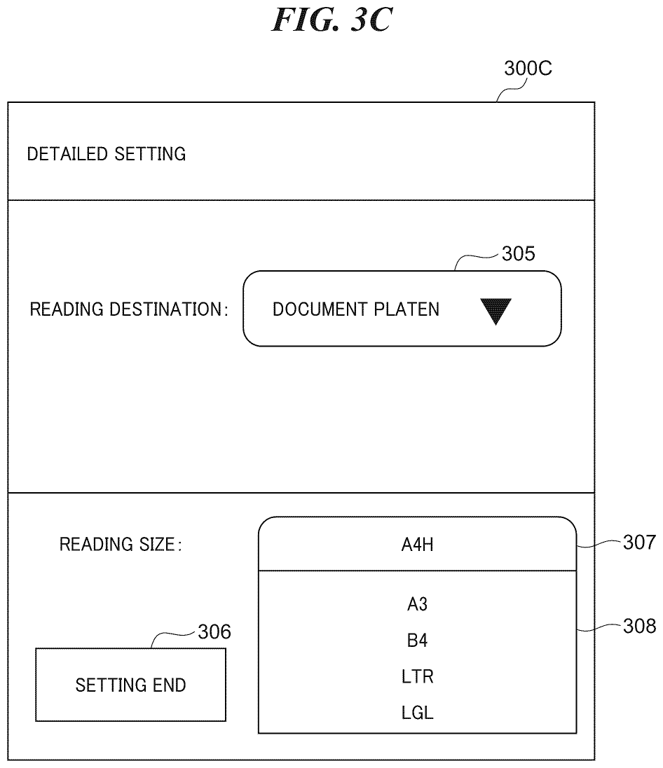

First, the configuration in the case where the extended application 204 has not been associated with the general purpose scan software 202 and the scan apparatus 102 will be described with reference to FIG. 2A. A scan application 201 is software that imports contents (image data) generated by scanning with the scan apparatus 102. The scan application 201 is not particularly limited, and examples of the scan application 201 include, for example, a document creation application, an image editing application, etc. The scan application 201 issues a scan instruction to the OS by receiving a scan request from, for example, a user. The scan instruction includes scan setting information for instructing the operations of the general purpose scan software 202 and the scan apparatus 102. In order to issue the scan instruction, the scan application 201 is able to cause the display unit 119 to display the scan setting screen 300A (see FIG. 3A) provided by any one of the general purpose scan software 202, the OS, and the scan application 201. In addition, when a control 302 within the scan setting screen 300A is operated (pressed), it is possible to cause the display unit 119 to display a detailed setting screen 300B (see FIG. 3B) or the detailed setting screen 300C (see FIG. 3C). The scan setting screen 300A, the detailed setting screen 300B, and the detailed setting screen 300C will be described below. The scan setting screen 300A includes setting items indicating scan functions that can be set and control items indicating their setting values, according to capability information obtained by the general purpose scan software 202, that is, information that is capable of being set as a scan setting. “The capability information” is information about the capabilities of the scan apparatus 102 to perform scanning. In addition, based on this capability information, it is also possible to determine whether or not information that enables the display of the detailed setting screen 300C is included. As a result of this determination, in the case of being determined that the information that enables the display of the detailed setting screen 300C is included, it is possible to cause to display the detailed setting screen 300C. On the other hand, in the case of being determined that the information that enables the display of the detailed setting screen 300C is not included, the detailed setting screen 300C will not be displayed.

Scan function information 203 is data indicating scan functions in which all settable scan functions, their setting values, exclusive relationships between the setting values, and the like have been described. The scan function information 203 is included in the configuration file of the general purpose scan software 202 and is placed in the external storage device 114 as an unchangeable file. Alternatively, the scan function information 203 is dynamically generated by the general purpose scan software 202. Specifically, the general purpose scan software 202 obtains attribute data of the scan apparatus 102 from the scan apparatus 102. The general purpose scan software 202 generates the scan function information 203 according to attribute information within this attribute data. It should be noted that in the case where the scan function information 203 is dynamically generated in this way, editing of the scan function information 203 is possible. In addition, the attribute data of the scan apparatus 102 includes attribute information indicating functions that are capable of being designated in the scan apparatus 102 (attribute information indicating the capabilities of the scan apparatus 102) and setting values related to the attribute information, which are stored in the RAM 113.

With such a configuration, the general purpose scan software 202 allows the user to designate scan functions that are capable of being used in the scan apparatus 102, depending on the scan apparatus 102 connected to the host computer 101. As a result, regardless of the scan apparatus 102, that is, even in the case where a scan apparatus with different functions or a scan apparatus developed by a different scan manufacturer is connected, it becomes possible to designate scan functions that are capable of being used in the scan apparatus with different functions or the scan apparatus developed by the different scan manufacturer. It should be noted that in the first embodiment, it is assumed that the general purpose scan software 202 is a standard class driver that executes scanning based on a standard scan protocol called Mopria. Specifically, the general purpose scan software 202 is not a unique scan driver depending on the model of the scan apparatus 102, but a standard class driver that is capable of being used in common by the scan apparatuses 102 of various scan manufacturers regardless of the scan manufacturer. In addition, the general purpose scan software 202 obtains capability information of the scan apparatus 102, and generates the scan function information 203 based on the capability information of the scan apparatus 102.

In addition, it is possible to associate the general purpose scan software 202 with the extended application 204. As a result, it is possible to execute functions, which are not included in the general purpose scan software 202, by the general purpose scan software 202. For example, with the general purpose scan software 202, it is not possible to accept setting of a scanning condition, such as a reading size of a document, for a document (an image) to be scanned by the scan apparatus 102. In other words, the general purpose scan software 202 does not support the setting of the scanning condition. This is because the setting of the scanning condition is a function that is executed independently by the scan apparatus 102 manufactured by the predetermined scan manufacturer. The extended application 204 is able to be extended to be capable of executing the setting of the scanning condition that the general purpose scan software 202 is not able to execute. In the first embodiment, the general purpose scan software 202 is not able to set the scanning condition, and the extended application 204 is able to be extended to be capable of executing the setting of the scanning condition, but the present invention is not limited to this. For example, the general purpose scan software 202 may be able to execute a part of the setting of the scanning condition, and the extended application 204 may supplement the shortage of the setting of the scanning condition to further extend the scope of the execution.

The configuration in the case where the extended application 204 has been associated with the general purpose scan software 202 and the scan apparatus 102 will be described with reference to FIG. 2B. As shown in FIG. 2B, unlike FIG. 2A, the extended application 204 has been added. In other words, the host computer 101 includes the scan application 201, the general purpose scan software 202, and the scan function information 203, and further includes the extended application 204. The extended application 204 is software for extending the functions of the general purpose scan software 202, and is sometimes simply referred to as “scan software”. It should be noted that the extended application 204 is software that is not included in the OS in advance (is not bundled with the OS). Therefore, the extended application 204 is downloaded from a server (not shown) via the Internet by the user operating the host computer 101, and is installed into the host computer 101. Alternatively, when the scan apparatus 102 is connected to the host computer 101, the extended application 204 may be automatically installed into the host computer 101 based on this connection. Specifically, in the case where the scan apparatus 102 is connected to the host computer 101, the OS obtains device identification information from the scan apparatus 102. The OS may download the extended application 204 corresponding to this device identification information from the server via the Internet and then install it. As a result, the general purpose scan software 202 and the extended application 204 are retained in the host computer 101 as separate control programs. It should be noted that the general purpose scan software 202 and the extended application 204 may be updated and upgraded, respectively. In this case, an update processing of the general purpose scan software 202 and an update processing of the extended application 204 may be performed at the same timing or at different timings. In addition, a trigger for the host computer 101 to obtain the general purpose scan software 202 and a trigger for the host computer 101 to obtain the extended application 204 may be the same trigger or may be different triggers. In addition, in the case where the extended application 204 has been installed, the OS associates the extended application 204 with the general purpose scan software 202 and the scan apparatus 102.

As shown in FIG. 2B, the extended application 204 is capable of exchanging information with the general purpose scan software 202 and the scan apparatus 102, respectively, that is, the extended application 204 is capable of transmitting and receiving information to and from the general purpose scan software 202 and the scan apparatus 102, respectively. In other words, the extended application 204 has been associated with the general purpose scan software 202 and the scan apparatus 102. In the first embodiment, the extended application 204 includes a scan setting screen extending unit 205, a scan function extending unit 206, an image data editing unit 207, and a notifying unit 209. In addition, the extended application 204 includes shared information 208 that is capable of being accessed from each unit of the scan setting screen extending unit 205, the scan function extending unit 206, the image data editing unit 207, and the notifying unit 209. The shared information 208 is a file that has been stored in the external storage device 114 or information that has been stored in the RAM 113. The extended application 204 is able to perform writing and reading of the shared information 208 by using an application program interface (an API) provided by the OS.

It should be noted that the extended application 204 may end the operation of the extended application 204 as a whole when the processing of each unit of the scan setting screen extending unit 205, the scan function extending unit 206, the image data editing unit 207, and the notifying unit 209 ends. In this case, the OS activates the extended application 204 every time the OS receives a processing execution request from each unit of the scan setting screen extending unit 205, the scan function extending unit 206, the image data editing unit 207, and the notifying unit 209. In addition, the extended application 204 may cancel the processing of each unit of the scan setting screen extending unit 205, the scan function extending unit 206, the image data editing unit 207, and the notifying unit 209 during the processing of each unit of the scan setting screen extending unit 205, the scan function extending unit 206, the image data editing unit 207, and the notifying unit 209. In this case, a job being processed on a print queue is deleted by the OS. As described above, the scan application 201 issues a scan instruction to the OS upon receiving a scan request from the user. In addition, the scan application 201 is able to cause to display a scan setting screen. In the configuration shown in FIG. 2B, the scan application 201 is able to cause to display the scan setting screen 300A (the detailed setting screen 300C) provided by the scan setting screen extending unit 205 (the extended application 204). In addition, the scan setting screen extending unit 205 is able to store, in the shared information 208, a detailed setting that has been set by the user.

The image data editing unit 207 obtains the image data from the general purpose scan software 202. In addition, after obtaining the image data, the image data editing unit 207 is also able to edit the image data. In addition, the image data editing unit 207 obtains detailed setting information from the shared information 208, and performs image editing on the image data in accordance with the detailed setting information. The extended application 204 may perform image editing on the image data, which has been obtained by the general purpose scan software 202, in accordance with the detailed setting information. In addition, even in the case of the configuration of FIG. 2B, there is a case where the setting of the scanning condition is not executed. In this case, the general purpose scan software 202 may transmit a scan request instruction to the scan apparatus 102 without going through the extended application 204.

The scan function extending unit 206 is able to edit the scan function information 203 that has been generated by the general purpose scan software 202 or the OS. As a result, it is possible to perform the addition of functions provided by the extended application 204. In addition, it is also possible to perform the addition of the function (for example, a scanning condition setting function) that can be executed by the scan apparatus 102, but cannot be executed by the general purpose scan software 202, the addition of the exclusive relationships between the setting values of the scan functions, and the like. The OS activates the scan function extending unit 206 when the extended application 204 has been first associated with the scan apparatus 102 and the general purpose scan software 202. In addition, the OS may activate the scan function extending unit 206 at other timings (for example, when the OS is activated). With such activation, even in the case where a scanning-related function is extended later, the scan function extending unit 206 is able to detect the extended scanning-related function and add it to the scan function information 203.

The notifying unit 209 is able to, when an error occurs in the scan apparatus 102, notify that the error occurs in the scan apparatus 102. For example, in the case where a reading jam error occurs in the scan apparatus 102, the general purpose scan software 202 detects the occurrence of this reading jam error. By using a notifying function called a toast notification, which is one of the functions of the OS, the OS causes the display unit 119 to display the occurrence of the reading jam error, which is a detection result obtained by the general purpose scan software 202, as a message. It should be noted that when the user operates the toast notification, the notifying unit 209 is called out by the OS, and a user interface screen (a UI screen) of the notifying unit 209 is displayed. On the user interface screen, for example, a detailed message regarding the reading jam error, a method for clearing the jam, etc. are capable of being displayed.

As described above, in the first embodiment, it can be said that the extended application 204 includes the following four functions. The first function is a function to display a setting screen. The first function is executed by the scan setting screen extending unit 205. The second function is a function to edit the image data in accordance with the detailed setting information. The second function is executed by the image data editing unit 207. The third function is a function to extend the functions that are capable of being designated by image data generation software. The third function is executed by the scan function extending unit 206. The fourth function is a function to display a screen in response to the occurrence of an error in the scan apparatus 102. The fourth function is executed by the notifying unit 209. It should be noted that the configuration of the extended application 204 is not limited to the configuration having these four functions, and it is preferable that the configuration of the extended application 204 is a configuration having at least one function of these functions, and may also have other functions.

### Example of Scan Setting Screen/Detailed Setting Screen

FIGS. 3A, 3B, and 3C are diagrams that show examples of screens displayed on the display unit of the scan system. FIG. 3A shows a scan setting screen displayed by the scan application 201. FIG. 3B shows a detailed setting screen that is displayed in the case of the configuration in which the extended application 204 has not been associated. FIG. 3C shows a detailed setting screen that is displayed in the case of the configuration in which the extended application 204 has been associated. It should be noted that the unit or the module that displays each screen is not particularly limited. For example, the scan setting screen extending unit 205 may be configured to only generate a display screen. In this case, the scan setting screen extending unit 205 transmits the generated display screen to the scan application 201 via the general purpose scan software 202. The scan application 201 may be configured to display the obtained display screen.

The scan setting screen 300A shown in FIG. 3A is a screen that allows to set a scanning condition related to scanning performed by the scan apparatus 102 (a screen on which the scanning condition related to scanning performed by the scan apparatus 102 is capable of being set). The scan setting screen 300A includes a control (a button) 301, the control 302, a control 303, and a control 304. By using the control 301, it is possible to select and set a scanner apparatus to be used for reading a document. In FIG. 3A, as an example, the scanner apparatus to be used for reading a document has been set to “scanner 001 (common driver)”. By using the control 302, it is possible to perform a detailed setting of the scanning condition. By using the control 303, it is possible to instruct the scan apparatus 102 to start scanning. By using the control 304, it is possible to instruct the scan apparatus 102 to cancel scanning.

In the case of the configuration in which the extended application 204 has not been associated, by operating the control 302, the detailed setting screen 300B shown in FIG. 3B is displayed. The detailed setting screen 300B includes a control 305 and a control 306. By using the control 305, it is possible to select and set a reading destination of the document in the scan apparatus 102, that is, a placement portion on which the document to be read is placed. For example, in the case where the scan apparatus 102 has a document platen (a document platen glass) and a feeder as the reading destination of the document, in FIG. 3B, as an example, “document platen” has been selected. By using the control 306, it is possible to end the setting performed by the control 305. In addition, by operating the control 306, returning to the scan setting screen 300A shown in FIG. 3A.

In the case of the configuration in which the extended application 204 has been associated, by operating the control 302, the detailed setting screen 300C (a setting acceptance screen) shown in FIG. 3C is displayed (a display control step). It should be noted that although the detailed setting screen 300C is a screen that is displayed together with the scan setting screen 300A, the display form thereof is not particularly limited. For example, the detailed setting screen 300C may be displayed overlapping the scan setting screen 300A. Furthermore, the detail setting screen 300C may be displayed adjacent to the scan setting screen 300A, or the scan setting screen 300A may disappear once and then the detail setting screen 300C may be displayed. Similar to the detailed setting screen 300B, the detailed setting screen 300C includes the control 305 and the control 306. In addition, the detailed setting screen 300C further includes a control 307. By using the control 307, as the scanning condition for the scan apparatus 102, it is possible to accept setting of the reading size of the document. By operating the control 307, a list 308 is displayed. As the reading size of the document, the list 308 includes “A4H”, “A3”, “B4”, “LTR”, and “LGL”. In FIG. 3C, as an example, “A4H” has been selected. In this way, the list 308 allows the user to select a desired reading size from a plurality of reading sizes (a plurality of options). Furthermore, by operating the control 306 while “A4H” has been selected, it is possible to cause to decide the end of the setting performed by the control 307, that is, the end of the reading size setting. In this way, on the detailed setting screen 300C, the control 306 functions as a decision operation section that causes to decide the end of the reading size setting. In the case where the end of the reading size setting has been decided, it is possible to cause the scan apparatus 102 to read the document under the scanning condition that has been accepted on the detailed setting screen 300C, that is, read the document in accordance with the reading size “A4H” (a reading step).

Here, the reason why the items included in the detailed setting screen 300B shown in FIG. 3B are different from the items included in the detailed setting screen 300C shown in FIG. 3C will be described. In other words, the reason why it is possible to switch between displaying the detailed setting screen 300B and displaying the detailed setting screen 300C will be described. The detailed setting screen 300B and the detailed setting screen 300C are each generated based on the scan function information (the capability information). As described above, the general purpose scan software 202 does not support the scanning condition setting. Therefore, it is not possible to add the scanning condition setting function to the scan function information by using only the general purpose scan software 202. In addition, even in the case where the scan function information originally includes the scanning condition setting function, the general purpose scan software 202 is not able to interpret the scanning condition setting function that is included in the scan function information. Therefore, it is not possible to display the scanning condition setting on the detailed setting screen. Therefore, the scan function extending unit 206 adds the scanning condition setting function to the scan function information 203. Then, the scan setting screen extending unit 205 refers to the capability information and causes to display the detailed setting screen 300C. This detailed setting screen 300C becomes a screen on which the scanning condition is capable of being set. It should be noted that the detailed setting screen 300C may further include setting item(s) other than the scanning condition setting.

<Flowchart of Scan Function Extending Unit that Edits Scan Function Information>

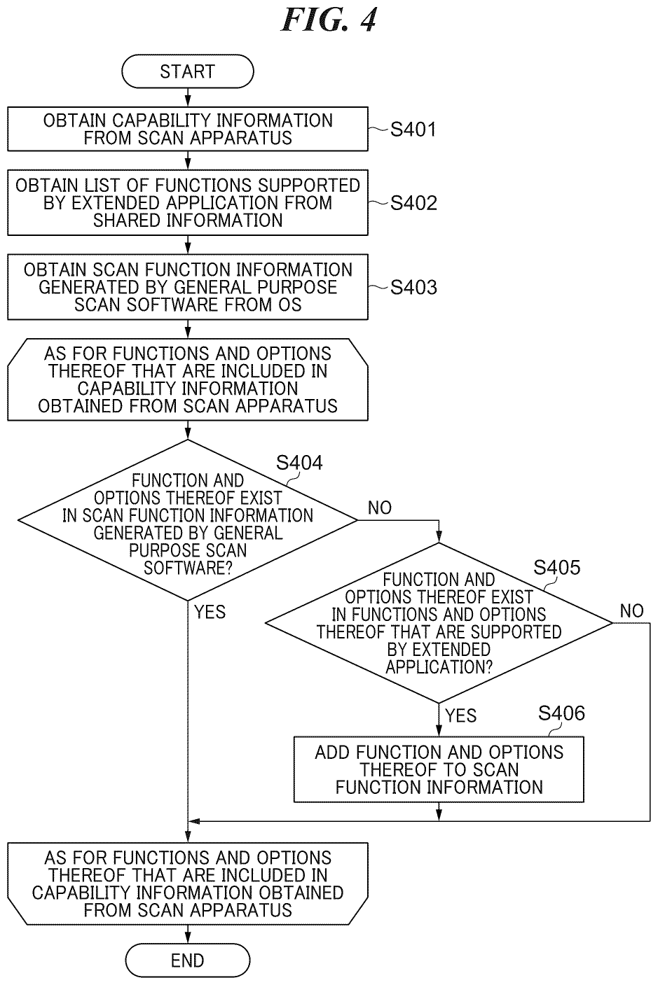

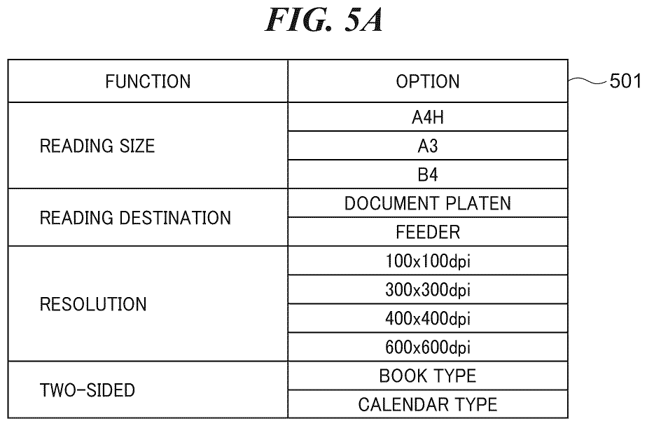

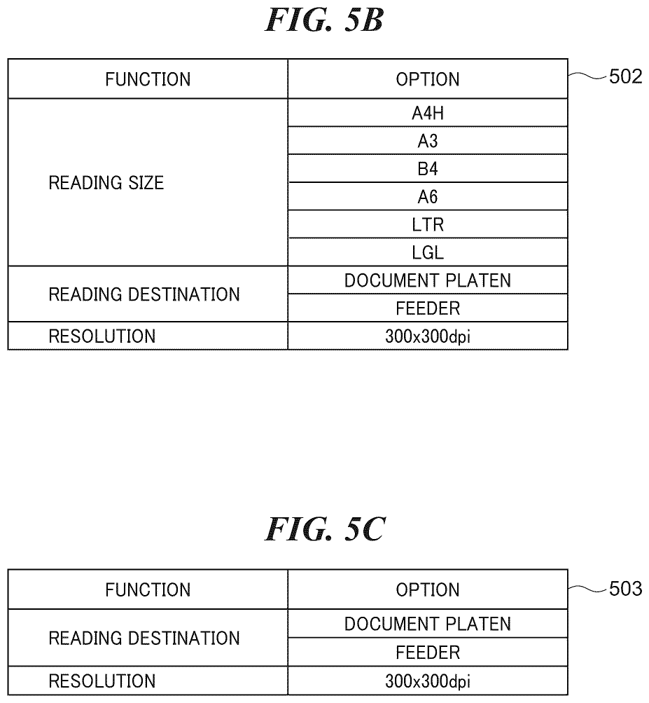

FIG. 4 is a flowchart that shows a processing in which the scan function extending unit edits the scan function information. It should be noted that a program based on the flowchart shown in FIG. 4 is executed by the CPU 111 controlling the scan function extending unit 206. FIGS. 5A, 5B, and 5C are diagrams that show examples of a list table of scan information. As shown in FIG. 4, in a step S401, the scan function extending unit 206 obtains the capability information from the scan apparatus 102. The capability information includes the attribute information indicating the functions that are capable of being designated in the scan apparatus 102, and the setting values related to the attribute information. A table 501 shown in FIG. 5A shows a list of the capability information that has been obtained from the scan apparatus 102. As shown in the table 501, it is possible from the scan apparatus 102 to obtain functions such as a reading size setting function, and options that can be set for each of the functions. For example, in the reading size setting function, options thereof are “A4H”, “A3”, and “B4”.

In a step S402, the scan function extending unit 206 obtains the scan functions supported by the extended application 204 from the shared information 208. A list of the scan functions supported by the extended application 204 has been stored in the shared information 208. A table 502 shown in FIG. 5B includes all scan functions that can be executed by the extended application 204 (all scan functions that can be supported by the extended application 204) and their setting values. For example, in the reading size setting function, options thereof are “A4H”, “A3”, “B4”, “A6”, “LTR”, “LGL”. In addition, the scan functions that can be executed by the extended application 204 may be updated by, for example, updating the extended application 204.

In a step S403, the scan function extending unit 206 obtains the scan function information 203, which has been created by the general purpose scan software 202, from the OS. The scan function information 203 is created based on the capability information, which has been obtained by the general purpose scan software 202 from the scan apparatus 102. The scan function information 203 created by the general purpose scan software 202 includes only the scan functions that can be executed by the general purpose scan software 202 out of the capability information obtained from the scan apparatus 102. A table 503 shown in FIG. 5C includes all scan functions that can be executed by the general purpose scan software 202 and their setting values. As shown in the table 503, the scan functions that can be executed by the general purpose scan software 202 do not include the reading size setting function. Therefore, the scan function information 203 does not include the reading size setting. The scan function extending unit 206 adds functions and options thereof to the scan function information 203, which enables the extended application 204 to compensate for insufficient functions of the general purpose scan software 202. In addition, the scan function extending unit 206 is also able to delete unnecessary functions and options thereof from the scan function information 203 created by the general purpose scan software 202.

Steps S404, S405, and S406 are processes that are repeatedly performed for the list of the functions included in the capability information that has been obtained from the scan apparatus 102 in the step S401. In the first embodiment, the steps S404, S405, and S406 are repeatedly performed for all nine options included in the table 501 (excluding options of a two-sided setting function).

In the step S404, the scan function extending unit 206 determines whether or not the function currently being processed and options thereof exist in the scan function information 203 that has been generated by the general purpose scan software 202. As a result of the determination in the step S404, in the case of being determined that the function currently being processed and options thereof exist in the scan function information 203, if the last item in the options is being processed, the processing ends. Alternatively, if the last item in the options is not being processed, the next item in the options is selected and the step S404 is executed again. On the other hand, as the result of the determination in the step S404, in the case of being determined that the function currently being processed and options thereof do not exist in the scan function information 203, the processing proceeds to the step S405. For example, in the first embodiment, the table 501 includes the reading destination “document platen”, and the table 503 also includes the reading destination “document platen”. In this case, in the step S404, it is determined that the function currently being processed and options thereof exist in the scan function information 203. On the other hand, the table 501 includes the reading size “A4H”, but the table 503 does not include the reading size “A4H”. In this case, in the step S404, it is determined that the function currently being processed and options thereof do not exist in the scan function information 203.

In the step S405, the scan function extending unit 206 determines whether or not the function currently being processed (and options thereof) exist in the functions (and options thereof) supported by the extended application 204. As a result of the determination in the step S405, in the case of being determined that the function currently being processed (and options thereof) exist in the functions (and options thereof) supported by the extended application 204, the processing proceeds to the step S406. On the other hand, as the result of the determination in the step S405, in the case of being determined that the function currently being processed (and options thereof) do not exist in the functions (and options thereof) supported by the extended application 204, as in the case of being determined “YES” in the step S404, if the last item in the options is being processed, the processing ends. Alternatively, if the last item in the options is not being processed, the next item in the options is selected and the step S404 is executed again. For example, in the first embodiment, in the case that the function currently being processed is the reading size “A4H”, the reading size “A4H” also exists in the table 502. Therefore, in the step S405, it is determined that the function currently being processed (and options thereof) exist in the functions (and options thereof) supported by the extended application 204.

In the step S406, the scan function extending unit 206 adds the function currently being processed (and options thereof) to the scan function information 203. After the step S406 is executed, as in the case of being determined “YES” in the step S404, if the last item in the options is being processed, the processing ends. Alternatively, if the last item in the options is not being processed, the next item in the options is selected and the step S404 is executed again.

As described above, the extended application 204 is able to add, to the scan function information 203, the functions (and options thereof) that are not supported by the general purpose scan software 202, are capable of being supported by the scan apparatus 102, and are capable of being supported by the extended application 204. Then, the capability information is generated based on the scan function information 203 that has been edited by this adding process. Furthermore, the scan setting screen extending unit 205 is able to generate the display screen based on this capability information, thereby extending the functions that are not supported by the general purpose scan software 202, and displaying the detailed setting screen 300C shown in FIG. 3C.

<Processes after Scan Application Accepts Scan Setting>

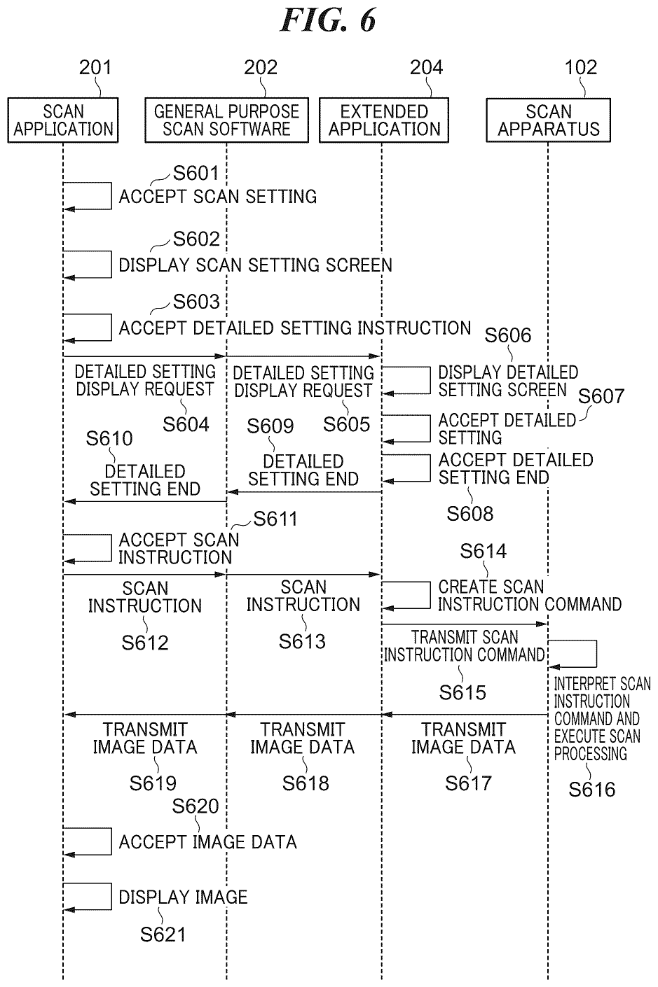

FIG. 6 is a sequence diagram that shows processes executed between the scan application, the general purpose scan software, the extended application, and the scan apparatus after the scan application accepts a scan setting. The processes in the scan application, the general purpose scan software, and the extended application are executed by the CPU 111 of the host computer 101. This processing program has been stored in the external storage device 114. Furthermore, the CPU 111 loads the processing program from the external storage device 114 into the RAM 113 and executes it. In addition, the processes in the scan apparatus 102 are executed by the CPU 191 of the scan apparatus 102. This processing program has been stored in the external storage device 199. Furthermore, the CPU 191 loads the processing program from the external storage device 199 into the RAM 193 and executes it. In addition, the software configuration of the scan system 1000 is the software configuration shown in FIG. 2B.

As shown in FIG. 6, in a step S601, the scan application 201 accepts a scan setting from the user. The user is able to operate, for example, the pointing device 117 or the keyboard 118 to instruct the scan application 201 to perform the scan setting.

In a step S602, the scan application 201 displays the scan setting screen 300A shown in FIG. 3A on the display unit 119.

In a step S603, the scan application 201 accepts a detailed setting instruction from the user. The user is able to instruct to perform a detailed setting by, for example, operating the pointing device 117 or the keyboard 118 to select the control 302 on the scan setting screen 300A.

In a step S604, the scan application 201 makes a detailed setting display request with respect to the general purpose scan software 202.

In a step S605, the general purpose scan software 202 makes the detailed setting display request with respect to the extended application 204.

In a step S606, the scan setting screen extending unit 205 of the extended application 204 displays the detailed setting screen 300C shown in FIG. 3C on the display unit 119 in response to the detailed setting display request received in the step S605. As described above, a function that sets the reading size which is a reading condition (the reading size setting function) is added to the scan function information 203 by the scan function extending unit 206. The scan setting screen extending unit 205 is able to display the detailed setting screen 300C by referring to the capability information that has been generated based on the scan function information 203 to which the reading size setting function has been added. It should be noted that as necessary, the reading destination, a resolution, etc. may be displayed, or the display of the reading destination, the resolution, etc. may be inhibited or grayed out.

In a step S607, the scan setting screen extending unit 205 accepts a detailed setting made by the user on the detailed setting screen 300C. Here, as an example, it is assumed that on the detailed setting screen 300C, the reading destination “document platen” has been selected by the control 305, and the reading size “A4H” has been selected by the control 307 (see FIG. 3C). In this setting state, the scan setting screen extending unit 205 accepts that the user has operated the control 306 on the detailed setting screen 300C. As a result, the CPU 111 stores the setting state on the detailed setting screen 300C in the RAM 113.

In a step S608, the scan setting screen extending unit 205 accepts that the detailed setting made by the user has ended based on the operation of the control 306 in the step S607. The user is able to instruct to end the detailed setting by, for example, operating the pointing device 117 or the keyboard 118 to select the control 306. As a result, the setting state on the detailed setting screen 300C is written to the scan function information 203. It should be noted that the information written to the scan function information 203 may also include, for example, the above-described information that the display thereof is inhibited or that is grayed out.

In a step S609, the extended application 204 transmits, to the general purpose scan software 202, detailed setting end information indicating that the detailed setting has been ended in the step S608.

In a step S610, the general purpose scan software 202 receives the detailed setting end information that has been transmitted from the extended application 204 in the step S609. Then, the general purpose scan software 202 transmits this detailed setting end information to the scan application 201.

In a step S611, the scan application 201 accepts a scan instruction from the user. The user is able to issue the scan instruction by operating, for example, the pointing device 117 or the keyboard 118 to select the control 303 on the scan setting screen 300A (see FIG. 3A).

In a step S612, the scan application 201 issues the scan instruction that has been accepted in the step S611 to the general purpose scan software 202.

In a step S613, the general purpose scan software 202 accepts the scan instruction that has been issued in the step S612. Then, the general purpose scan software 202 issues this scan instruction to the extended application 204.

In a step S614, the extended application 204 accepts the scan instruction that has been issued in the step S613. Then, the extended application 204 creates a scan instruction command based on the scan function information 203 to which the setting state on the detailed setting screen 300C has been written in the step S608. It should be noted that this scan instruction command includes the setting information of the reading size (the reading size “A4H”) that has been accepted on the detailed setting screen 300C. In addition, there is a case where the above-described information that the display thereof is inhibited or that is grayed out has not been written to the scan function information 203 in the step S608. In this case, in the step S614, the extended application 204 may add, to the scan instruction command, the information that has not been written to the scan function information 203, or may set the information that has not been written to the scan function information 203 as default value(s).

In a step S615, the extended application 204 transmits, to the scan apparatus 102, the scan instruction command that has been created in the step S614.

In a step S616, the input/output interface 198 of the scan apparatus 102 receives the scan instruction command that has been transmitted in the step S615. Then, the reading unit 195 of the scan apparatus 102 interprets the scan instruction command and executes scanning under the setting condition on the detailed setting screen 300C (the reading step). As a result, as scanned image data (read image data), data of an A4 size portrait image is obtained. The image processing unit 190 of the scan apparatus 102 may perform necessary image processing on the scanned image data in accordance with the scan instruction.

In a step S617, the input/output interface 198 of the scan apparatus 102 transmits, to the extended application 204, the scanned image data that has been obtained in the step S616.

In a step S618, the extended application 204 receives the scanned image data that has been transmitted in the step S617. Then, the extended application 204 transmits this scanned image data to the general purpose scan software 202.

In a step S619, the general purpose scan software 202 receives the scanned image data that has been transmitted in the step S618. Then, the general purpose scan software 202 transmits this scanned image data to the scan application 201.

In a step S620, the scan application 201 receives the scanned image data that has been transmitted in the step S619.

In a step S621, the scan application 201 causes the display unit 119 to display the scanned image data that has been received in the step S620. As a result, the scanned image data, that is, the result of reading the document in the step S616, is displayed as a preview image on the display unit 119 (a preview image display step).

As described above, in the scan system 1000, even in the case where the general purpose scan software 202 does not support the reading size setting (the scanning condition setting), it is possible for the extended application 204 to execute the reading size setting. As a result, the scan apparatus 102 is capable of performing scanning under the reading size setting. It should be noted that in the description with reference to FIG. 6, it is assumed that the software configuration of the scan system 1000 is the software configuration shown in FIG. 2B and the detailed setting screen 300C shown in FIG. 3C is displayed, but the present invention is not limited to this. For example, in the case where the detailed setting display request has been made with respect to the general purpose scan software 202 in the step S604, the general purpose scan software 202 displays the detailed setting screen 300B shown in FIG. 3B. In this case, after the operation of the control 306 on the detailed setting screen 300B, the general purpose scan software 202 requests the extended application 204 to display an additional detailed setting screen. Next, the extended application 204 may cause to additionally display a detailed setting screen on which the reading size setting is capable of being performed.

In addition, the scan instruction in the step S613 is issued from the general purpose scan software 202 to the extended application 204, but the present invention is not limited to this. For example, the scan instruction may be issued from the scan application 201 to the extended application 204. In addition, a control for scan instruction may be arranged on the detailed setting screen 300C. In this case, a scan instruction is issued to the extended application 204 by the user operating the control for scan instruction. In addition, the scanned image data may be transmitted from the scan apparatus 102 to the scan application 201 via the extended application 204 without going through the general purpose scan software 202. In addition, the scanned image data may be transmitted directly from the scan apparatus 102 to the scan application 201. In addition, the scan system 1000 may be configured to be able to store the scanned image data in the external storage device 114 and transfer only information about a file path which is a storage destination. In addition, in the scan system 1000, in the case where there is a plurality of pieces of the scanned image data, all pieces of the scanned image data may be transmitted en bloc, or the scanned image data may be transmitted whenever it is obtained.

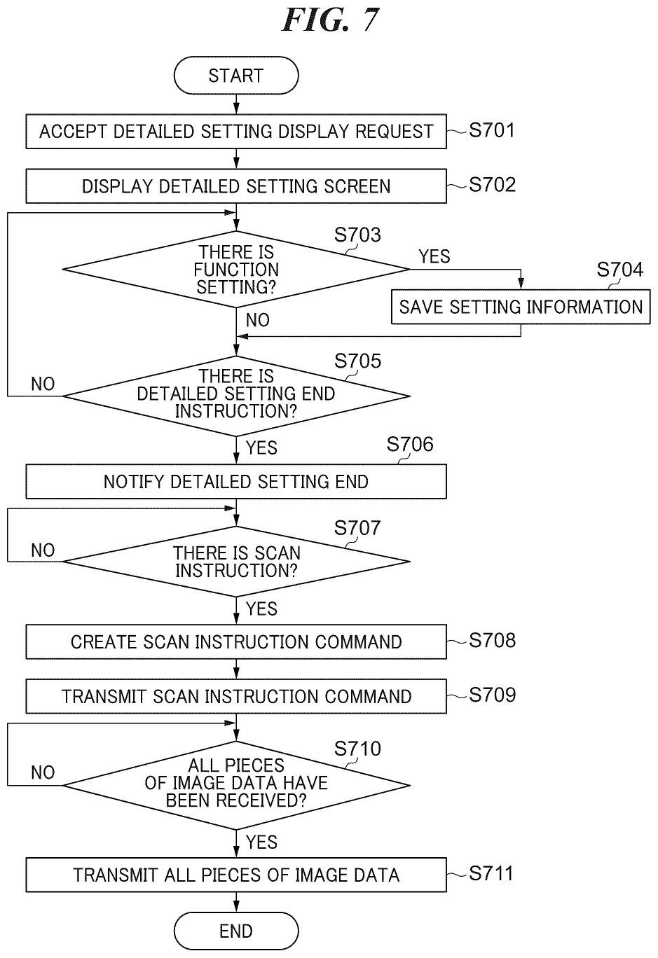

FIG. 7 is a flowchart that shows a processing executed by the extended application. A program based on the flowchart shown in FIG. 7 has been stored in the external storage device 114. The CPU 111 is able to execute this program by loading it from the external storage device 114 into the RAM 113. As shown in FIG. 7, in a step S701, the extended application 204 accepts the detailed setting display request (see the step S605) from the general purpose scan software 202.

In a step S702, the scan setting screen extending unit 205 of the extended application 204 displays the detailed setting screen 300C shown in FIG. 3C on the display unit 119 in response to the detailed setting display request that has been accepted in the step S701. As described above, the function that sets the reading size (the reading size setting function) is added to the scan function information 203. The scan setting screen extending unit 205 is able to display the detailed setting screen 300C by referring to the capability information that has been generated based on this scan function information 203.

In a step S703, the scan setting screen extending unit 205 determines whether or not the detailed setting has been performed on the detailed setting screen 300C, that is, whether or not selection operations with respect to the control 305 and the control 307 have been performed. As a result of the determination in the step S703, in the case of being determined that the detailed setting has been performed on the detailed setting screen 300C, the processing proceeds to a step S704. On the other hand, as the result of the determination in the step S703, in the case of being determined that the detailed setting has not been performed on the detailed setting screen 300C, the processing proceeds to a step S705.

In the step S704, the scan setting screen extending unit 205 stores (saves) the setting state on the detailed setting screen 300C (setting information) in the RAM 113.

In the step S705, the scan setting screen extending unit 205 determines whether or not an instruction to end the detailed setting (a detailed setting end instruction) has been given on the detailed setting screen 300C, that is, whether or not the operation with respect to the control 306 has been performed. As a result of the determination in the step S705, in the case of being determined that the detailed setting end instruction has been given on the detailed setting screen 300C, the processing proceeds to a step S706. On the other hand, as the result of the determination in the step S705, in the case of being determined that the detailed setting end instruction has not been given on the detailed setting screen 300C, the processing returns to the step S703, and the subsequent steps are executed in sequence.

In the step S706, the extended application 204 notifies the general purpose scan software 202 of the end of the detailed setting in the step S705.

In a step S707, the extended application 204 determines whether or not the scan instruction has been received from the general purpose scan software 202 (see the step S613). As a result of the determination in the step S707, in the case of being determined that the scan instruction has been received from the general purpose scan software 202, the processing proceeds to a step S708. On the other hand, as the result of the determination in the step S707, in the case of being determined that the scan instruction has not been received from the general purpose scan software 202, the processing remains in the step S707 and waits.

In the step S708, the extended application 204 creates a scan instruction command based on the scan function information 203 to which the setting state on the detailed setting screen 300C has been written. As described above, this scan instruction command includes the setting information of the reading size (the reading size “A4H”) that has been accepted on the detailed setting screen 300C. The setting information of the reading size may be an ID, or may be a numerical value converted into pixels or millimeter size taking into account the resolution. In addition, as a method for creating a scan instruction command, for example, there is a method for extending a command of a standard protocol. Furthermore, as this extension method, for example, there is a method of describing a dedicated command in an extension area of the command of the standard protocol. Other extension methods include, for example, a method in which a command based on a unique standard is added to the end of a command of a standard protocol, or a method in which the extended application 204 overwrites a command of a standard protocol with a unique command system. In addition, in the case of issuing an instruction from the extended application 204, the instruction and communication may be performed by using a manufacturer's unique protocol, regardless of the standard protocol.

In a step S709, the extended application 204 transmits, to the scan apparatus 102, the scan instruction command that has been created in the step S708.

In a step S710, the extended application 204 determines whether or not all pieces of the scanned image data from the scan apparatus 102 (see the step S617) have been received. As a result of the determination in the step S710, in the case of being determined that all pieces of the scanned image data from the scan apparatus 102 have been received, the processing proceeds to a step S711. On the other hand, as the result of the determination in the step S710, in the case of being determined that all pieces of the scanned image data from the scan apparatus 102 have not been received, the processing remains in the step S710 and waits.

In the step S711, the extended application 204 transmits, to the general purpose scan software 202, all pieces of the scanned image data from the scan apparatus 102, and the processing ends.

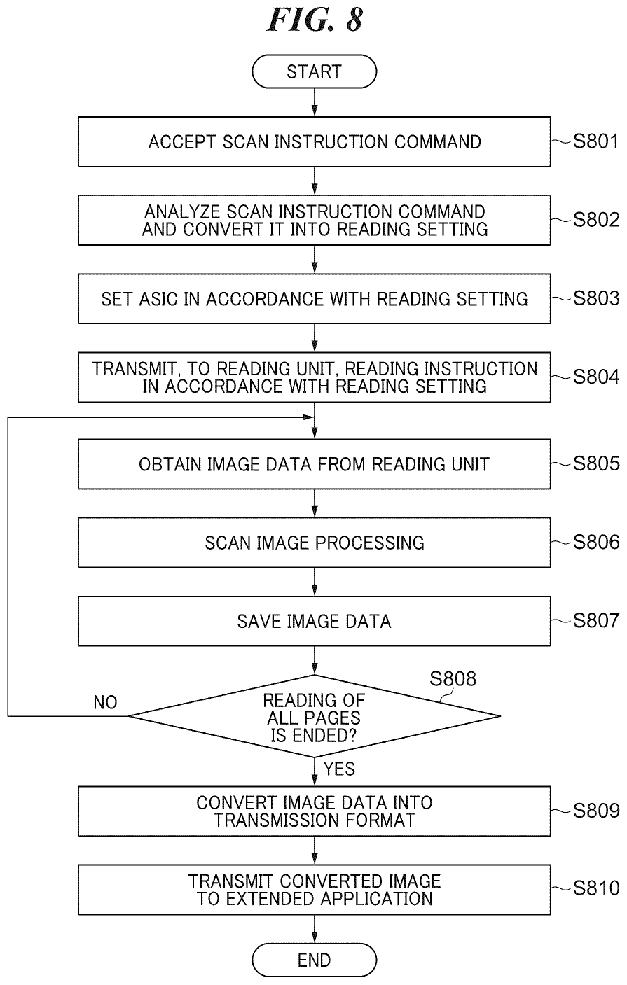

FIG. 8 is a flowchart that shows a processing executed by the scan apparatus. A program based on the flowchart shown in FIG. 8 has been stored in the external storage device 199. The CPU 191 is able to execute this program by loading it from the external storage device 199 into the RAM 192. As shown in FIG. 8, in a step S801, the CPU 191 accepts the scan instruction command (see the step S615) from the extended application 204.

In a step S802, the CPU 191 interprets the scan instruction command that has been accepted in the step S801. Then, the CPU 191 converts the scan instruction command into a setting that allows the scan apparatus 102 to execute a scan processing, that is, a setting that allows to execute scanning under the setting condition on the detailed setting screen 300C (the reading size “A4H”).

In a step S803, the CPU 191 decides an application specific integrated circuit (an ASIC) of the image processing unit 190 to be used for executing scanning in accordance with the setting in the step S802 (a reading setting), and sets the ASIC.

In a step S804, the CPU 191 transmits, to the reading unit 195, a reading instruction in accordance with the reading setting.

In a step S805, the CPU 191 obtains the scanned image data from the reading unit 195. The scanned image data is image data of A4H size.

In a step S806, the CPU 191 controls the image processing unit 190 to execute an image processing with respect to the scanned image data that has been obtained in the step S805. In the first embodiment, the image processing is, for example, a conversion processing to the resolution “300×300 dpi”. It should be noted that in the case where the reading unit 195 is capable of performing reading at the resolution “300×300 dpi”, the reading unit 195 may obtain the scanned image data at the resolution “300×300 dpi”. In this case, the step S806 can be omitted.

In a step S807, the CPU 191 saves the scanned image data in the external storage device 199.

In a step S808, the CPU 191 determines whether or not the scan processing with respect to all pages of the document to be read has been ended. As a result of the determination in the step S808, in the case of being determined that the scan processing with respect to all pages of the document to be read has been ended, the processing proceeds to a step S809. On the other hand, as the result of the determination in the step S808, in the case of being determined that the scan processing with respect to all pages of the document to be read has not been ended, the processing returns to the step S805, and the subsequent steps are executed in sequence.

In the step S809, the CPU 191 controls the image processing unit 190 to convert the scanned image data that has been saved in the step S807 into a transmission format. In the first embodiment, the transmission format is not included in the scan instruction command that has been accepted in the step S801. Therefore, the scanned image data is converted to, but not limited to, the default JPEG of the scan apparatus 102.

In a step S810, the CPU 191 controls the input/output interface 198 to transmit, to the extended application 204, the scanned image data that has been converted in the step S809, and the processing ends.

### Second Embodiment

Hereinafter, a second embodiment of the present invention will be described with reference to FIGS. 8 to 12. The differences from the embodiment described above will be mainly described, and descriptions of similar matters will be omitted. Depending on the scan apparatus 102, the reading size may be limited due to considerations of cost, etc. The second embodiment is effective in such a case. Specifically, first, the reading size that can be read by the scan apparatus 102 is determined from the capability information of the scan apparatus 102. Next, in the case where the document to be read is the reading size that can be read by the scan apparatus 102, scan setting information is generated, and is transmitted to the scan apparatus 102. On the other hand, in the case where the document to be read is not the reading size that can be read by the scan apparatus 102, scan setting information is generated in accordance with a reading size larger than a designated size, and is transmitted to the scan apparatus 102. Thereafter, the extended application 204 cuts out the scanned image data that has been obtained by the scan apparatus 102 to the designated size. As a result, even in the case where the reading size is limited, it is possible to obtain the scanned image data.

In the second embodiment, it is assumed that the scan apparatus 102 is a scan apparatus that is not capable of performing reading of A6 size. Therefore, the capability information obtained from the scan apparatus 102 does not include the A6 size as a readable size. Therefore, when the extended application 204 includes a unit capable of executing a size cutout processing that cuts out the scanned image data to a predetermined size, the scan function extending unit 206 adds the A6 size to the scan function information 203 as a readable size. The image data editing unit 207 executes the size cutout processing with respect to the scanned image data that has been received from the scan apparatus 102 based on the reading size setting that has been set by the user.

<Flowchart of Scan Function Extending Unit that Edits Scan Function Information>

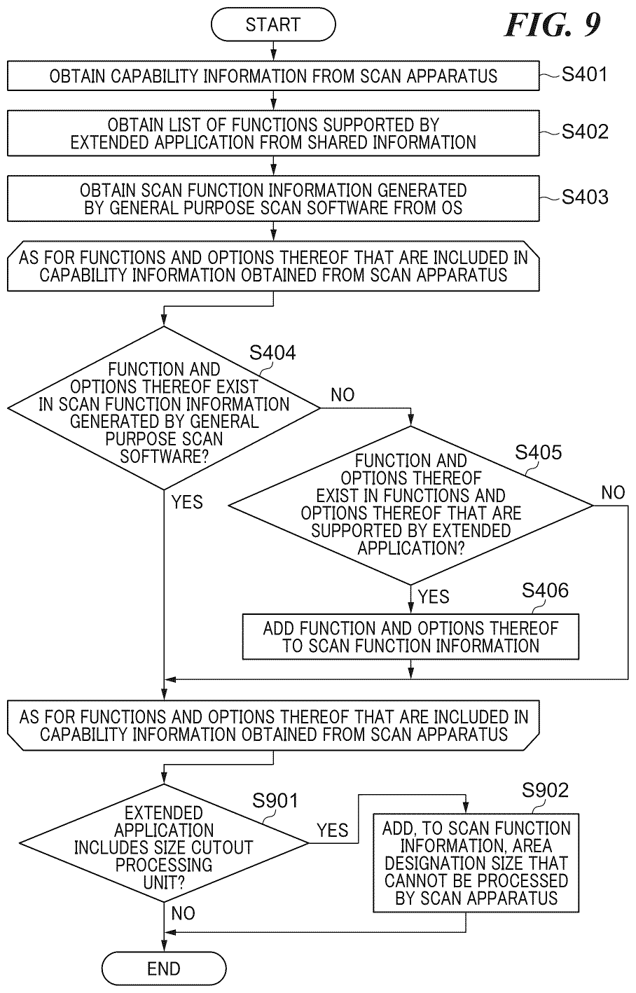

FIG. 9 is a flowchart that shows a processing in which the scan function extending unit edits the scan function information in the second embodiment. In the flowchart shown in FIG. 9, similar to the flowchart shown in FIG. 4, the steps S401 to S406 are executed. After this execution, the processing proceeds to a step S901. As described above, the scan apparatus 102 is an apparatus that is not capable of performing reading of the A6 size. Therefore, the A6 size has not been added as the reading size to the scan function information 203 after the repeated processing of the steps S404 to S406 is completed. In the step S901, the scan function extending unit 206 refers to the table 501 shown in FIG. 5A and the scan function information 203 to determine whether or not the extended application 204 includes the unit capable of executing the size cutout processing. As a result of the determination in the step S901, in the case of being determined that the extended application 204 includes the unit capable of executing the size cutout processing, the processing proceeds to a step S902. On the other hand, as the result of the determination in the step S901, in the case of being determined that the extended application 204 does not include the unit capable of executing the size cutout processing, the processing ends. In the second embodiment, since the image data editing unit 207 of the extended application 204 has the function as the unit capable of executing the size cutout processing (a size cutout processing unit), the processing proceeds to the step S902.

In the step S902, the scan function extending unit 206 adds the A6 size to the scan function information 203 as the reading size. As a result, even in the case where the scan apparatus 102 is an apparatus that is not capable of performing reading of the A6 size, the scan apparatus 102 is capable of performing scanning in the A6 size.

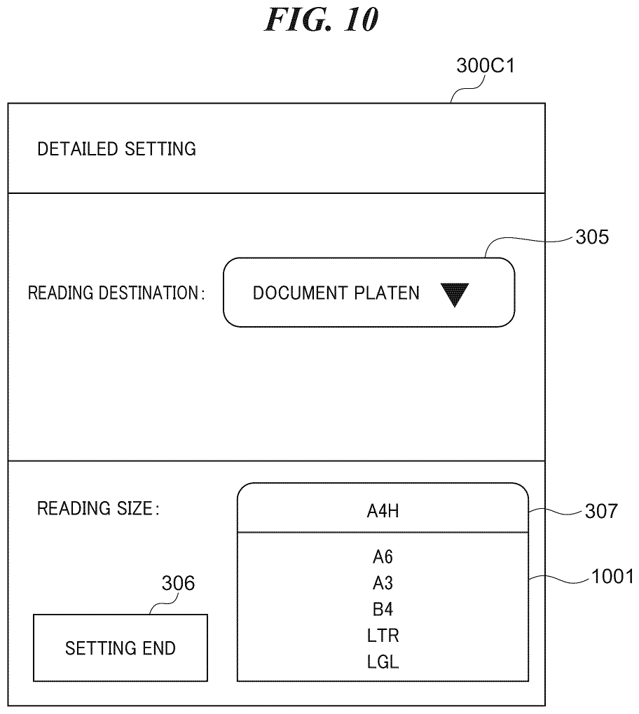

FIG. 10 is a diagram that show an example of the screen displayed on the display unit of the scan system. Similar to the detailed setting screen 300C (see FIG. 3C), a detailed setting screen 300C1 shown in FIG. 10 includes the control 305, the control 306, and the control 307. In addition, by operating the control 307, a list 1001 is displayed. As the reading size of the document, the list 1001 includes “A4H”, “A3”, “B4”, “LTR”, and “LGL”, and further includes “A6” due to addition. As a result, even if the reading size “A6” is the reading size that cannot be read by the scan apparatus 102, it is possible to select “A6” from the list 1001.

<Processes after Scan Application Accepts Scan Setting>

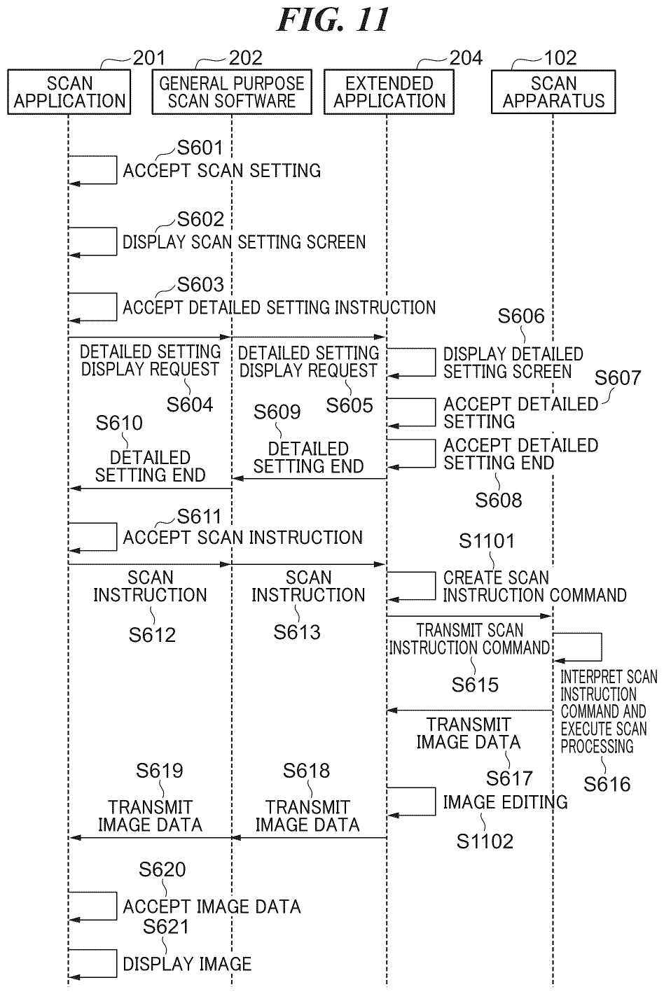

FIG. 11 is a sequence diagram that shows processes executed between the scan application, the general purpose scan software, the extended application, and the scan apparatus after the scan application accepts a scan setting. As shown in FIG. 11, a step S1101 is executed instead of the step S614 (see FIG. 6), and a step S1102 is executed between the step S617 and the step S618. In the step S1101, the extended application 204 creates a scan instruction command based on the scan function information 203 to which the setting state on the detailed setting screen 300C1 shown in FIG. 10 has been written.

In the step S1102, the image data editing unit 207 of the extended application 204 performs image editing that cuts out the scanned image data that has been transmitted in the step S617 to the A6 size.

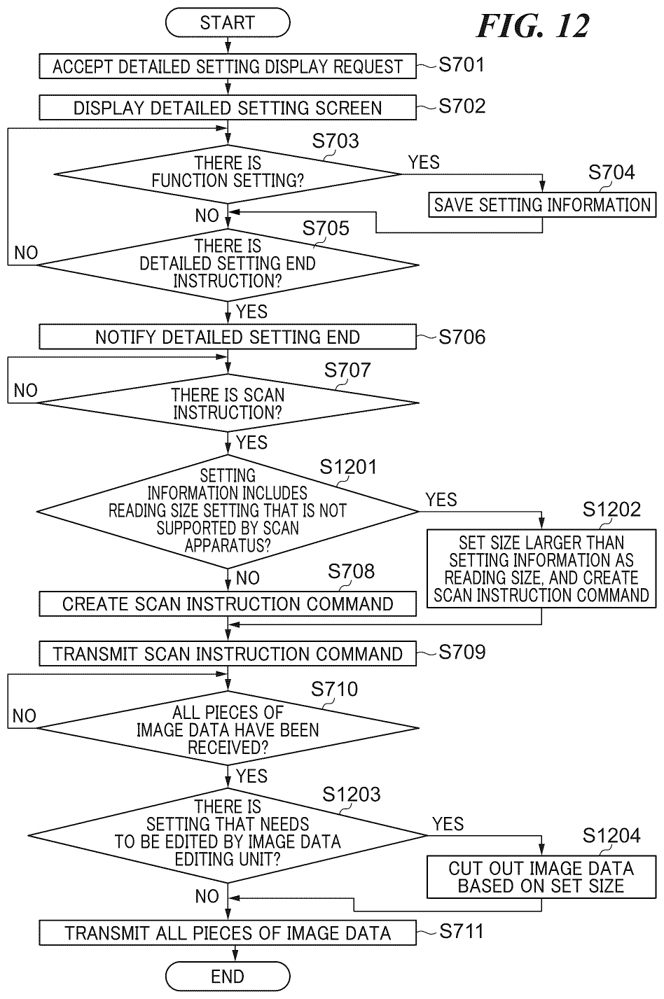

FIG. 12 is a flowchart that shows a processing executed by the extended application. As shown in FIG. 12, a step S1201 is executed between the step S707 and the step S708. Depending on a result of the determination in the step S1201, a step S1202 may be executed. In addition, a step S1203 is executed between the step S710 and the step S711. Depending on a result of the determination in the step S1203, a step S1204 may be executed.

In the step S1201 after the step S707 is executed, the extended application 204 obtains the capability information of the scan apparatus 102 from the shared information 208. It should be noted that in the case where the shared information 208 does not include the capability information of the scan apparatus 102, the scan function extending unit 206 may request the capability information from the scan apparatus 102 and save it in the shared information 208. The extended application 204 determines whether or not there is a reading size setting that cannot be executed (is not supported) by the scan apparatus 102 based on the capability information, and the setting state on the detailed setting screen 300C1. As the result of the determination in the step S1201, in the case of being determined that there is a reading size setting that cannot be executed by the scan apparatus 102, the processing proceeds to the step S1202. On the other hand, as the result of the determination in the step S1201, in the case of being determined that there is no reading size setting that cannot be executed by the scan apparatus 102, the processing proceeds to the step S708. It should be noted that in the second embodiment, although the scan apparatus 102 is an apparatus that is not capable of performing reading of the A6 size, since the reading size “A6” has been set on the detailed setting screen 300C1, the processing proceeds to the step S1202.

In the step S1202, the extended application 204 sets a reading size that is larger than the reading size set on the detailed setting screen 300C1 and can be read by the scan apparatus 102, and creates a scan instruction command. By setting a reading size larger than the reading size set on the detailed setting screen 300C1, in a later process (the step S1204), it is possible to perform cutting out of the scanned image. After the step S1202 is executed, the processing proceeds to the step S709.

In the step S1203 after the step S710 is executed, the extended application 204 determines whether or not there is a setting that needs to be edited by the image data editing unit 207 based on the setting state on the detailed setting screen 300C1. As a result of the determination in the step S1203, in the case of being determined that there is a setting that needs to be edited by the image data editing unit 207, the processing proceeds to the step S1204. On the other hand, as the result of the determination in the step S1203, in the case of being determined that there is no setting that needs to be edited by the image data editing unit 207, the processing proceeds to the step S711. It should be noted that in the second embodiment, since the A6 size, which cannot be read by the scan apparatus 102, has been set on the detailed setting screen 300C1, the processing proceeds to the step S1204.

In the step S1204, the image data editing unit 207 performs a cutout processing with respect to the scanned image data based on the reading size setting that has been set in the step S703. After the step S1204 is executed, the processing proceeds to the step S711.

### Third Embodiment

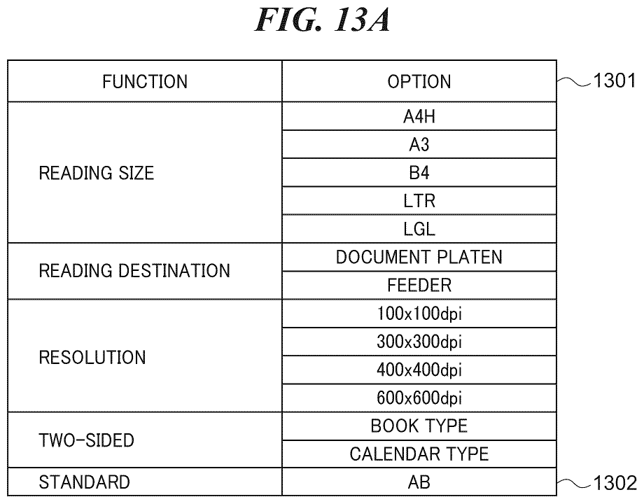

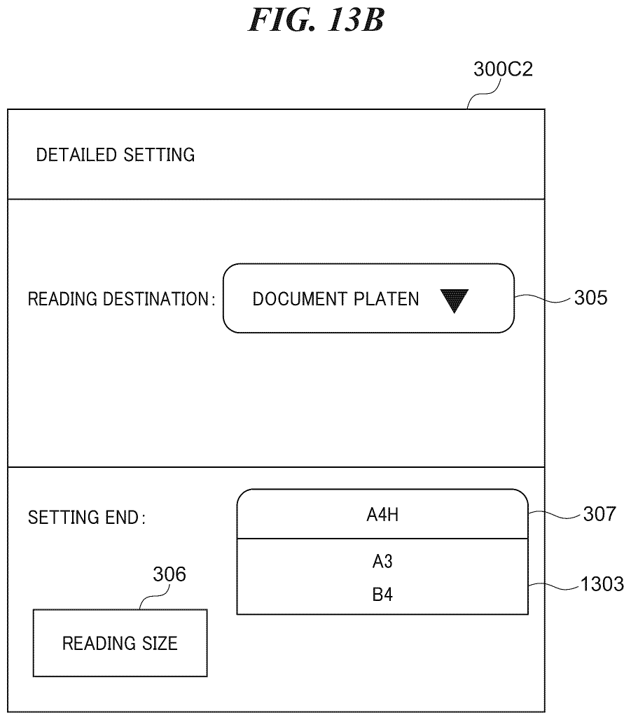

Hereinafter, a third embodiment of the present invention will be described with reference to FIGS. 13A to 16. The differences from the embodiments described above will be mainly described, and descriptions of similar matters will be omitted. FIGS. 13A and 13B are diagrams relating to the scan information in the third embodiment. A table 1301 shown in FIG. 13A shows an example of a list of the capability information that has been obtained from the scan apparatus 102. As shown in the table 1301, similar to the table 501 (see FIG. 5A), it is possible from the scan apparatus 102 to obtain functions such as a reading size setting function, and options that can be set for each of the functions. For example, in the reading size setting function, options thereof are “A4H”, “A3”, and “B4”. In addition, information 1302 has been further obtained from the scan apparatus 102 as standard information of the reading size. The information 1302 is the standard information of the AB system. In the case where the standard of the reading size set in the scan apparatus 102 is the AB system, the document to be read is also the AB system, and it is considered that the possibility of using a document in the inch system is low. In this case, even if inch system reading sizes are displayed as options, they will not be selected, and this will increase the labor required for the user to find an AB system reading size that he or she would actually like to select. Therefore, it is preferable to suppress the display of inch system options.

<Flowchart of Scan Function Extending Unit that Edits Scan Function Information>

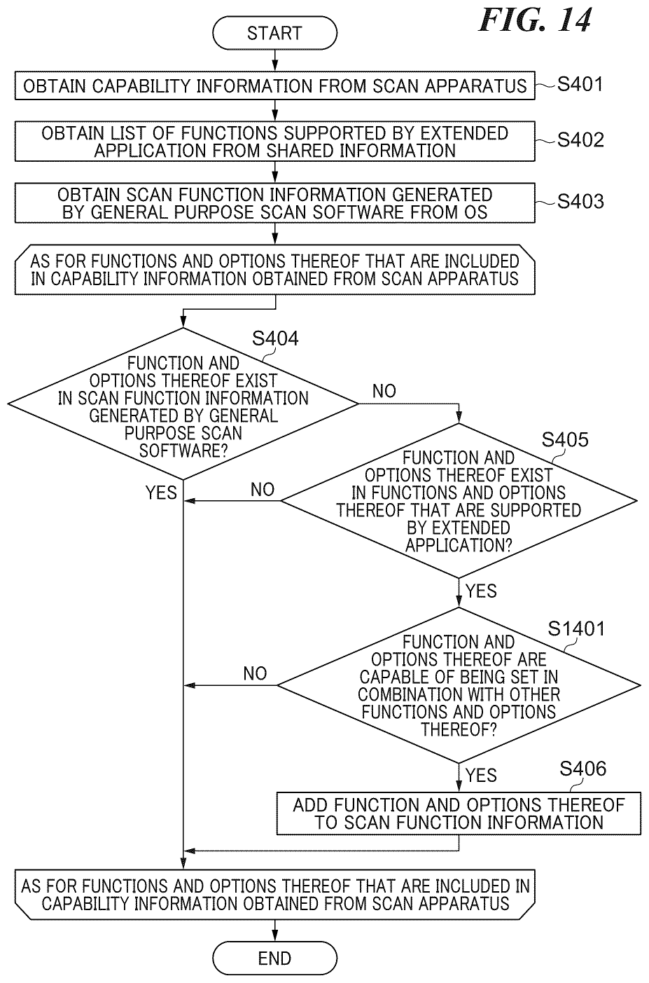

FIG. 14 is a flowchart that shows a processing in which the scan function extending unit edits the scan function information. In the flowchart shown in FIG. 14, similar to the flowchart shown in FIG. 4, the steps S401 to S406 are executed, but a step S1401 is executed between the step S405 and the step S406. In the step S1401, the scan function extending unit 206 determines whether or not the function currently being processed that has been executed by the extended application 204 (and options thereof) are capable of being set in combination with other functions (and options thereof). As a result of the determination in the step S1401, in the case of being determined that the function currently being processed that has been executed by the extended application 204 (and options thereof) are capable of being set in combination with other functions (and options thereof), the processing proceeds to the step S406. On the other hand, as the result of the determination in the step S1401, in the case of being determined that the function currently being processed that has been executed by the extended application 204 (and options thereof) are not capable of being set in combination with other functions (and options thereof), the processing is the same as in the case of being determined in the step S405 that the function currently being processed (and options thereof) do not exist. In the third embodiment, for example, in the case where the function currently being processed is the reading size “LTR”, it is necessary to determine whether or not the function currently being processed (the reading size “LTR”) is capable of being combined with the information 1302. Since the standard in the table 1301, which is the capability information of the scan apparatus 102, is the AB system (the information 1302), even if the standard (the AB system) is supported by the extended application 204, it is determined in the step S1401 that the function currently being processed (the reading size “LTR”) is not capable of being set in combination with the standard (the information 1302).

As described above, the scan function extending unit 206 is able to change the scan function information 203 regarding the combination of the functions that are not supported by the general purpose scan software 202, are supported by the scan apparatus 102, and are supported by the extended application 204. In addition, in accordance with the change of the scan function information 203, it becomes possible to display a detailed setting screen 300C2 shown in FIG. 13B. By operating the control 307 on the detailed setting screen 300C2, a list 1303 is displayed. The list 1303 includes, as the reading size of the document, “A4H”, “A3”, and “B34”, and has deleted “LTR” and “LGL”.

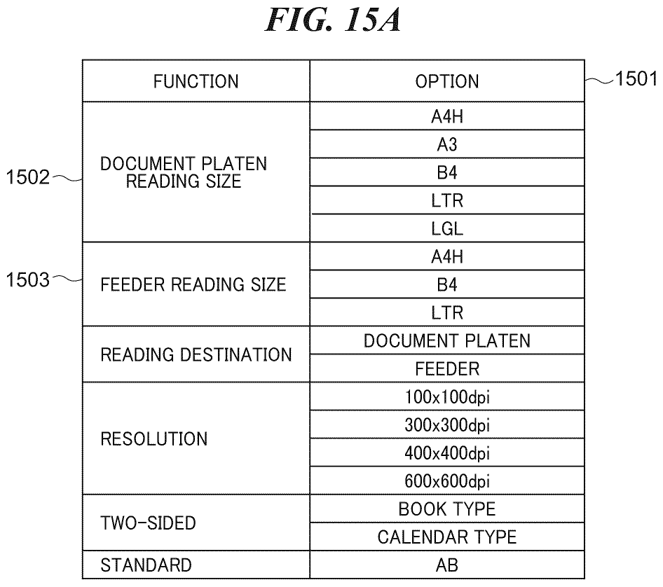

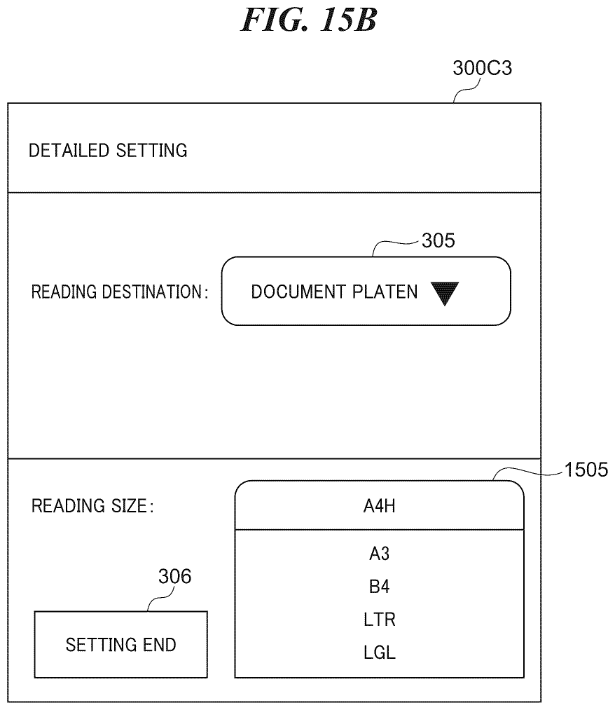

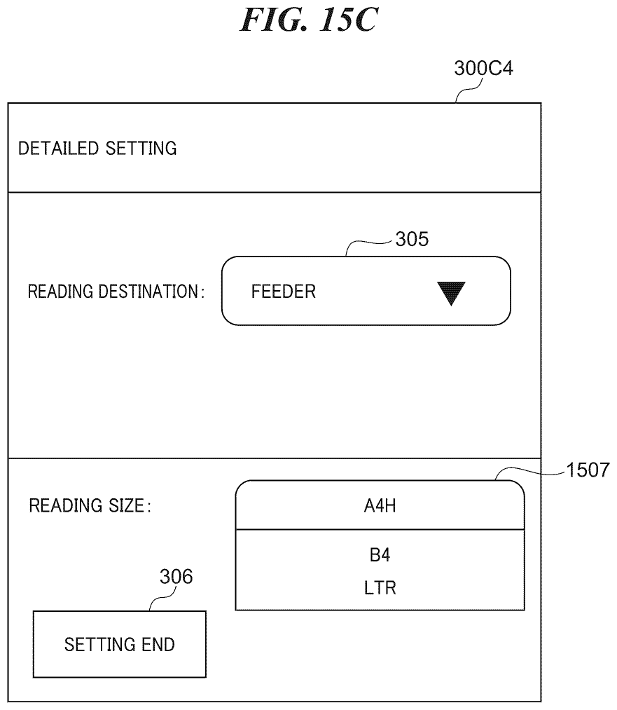

FIGS. 15A, 15B, and 15C are diagrams relating to the scan information (a modification). A table 1501 shown in FIG. 15A shows an example of a list of the capability information that has been obtained from the scan apparatus 102. As shown in the table 1501, it is possible from the scan apparatus 102 to obtain information 1502 about the reading size that can be read on the document platen and information 1503 about the reading size that can be read on the feeder. The information 1502 includes, as the reading size that can be read on the document platen, “A4H”, “A3”, “B4”, “LTR”, and “LGL”. The information 1503 includes, as the reading size that can be read on the feeder, “A4H”, “B4”, and “LTR”.

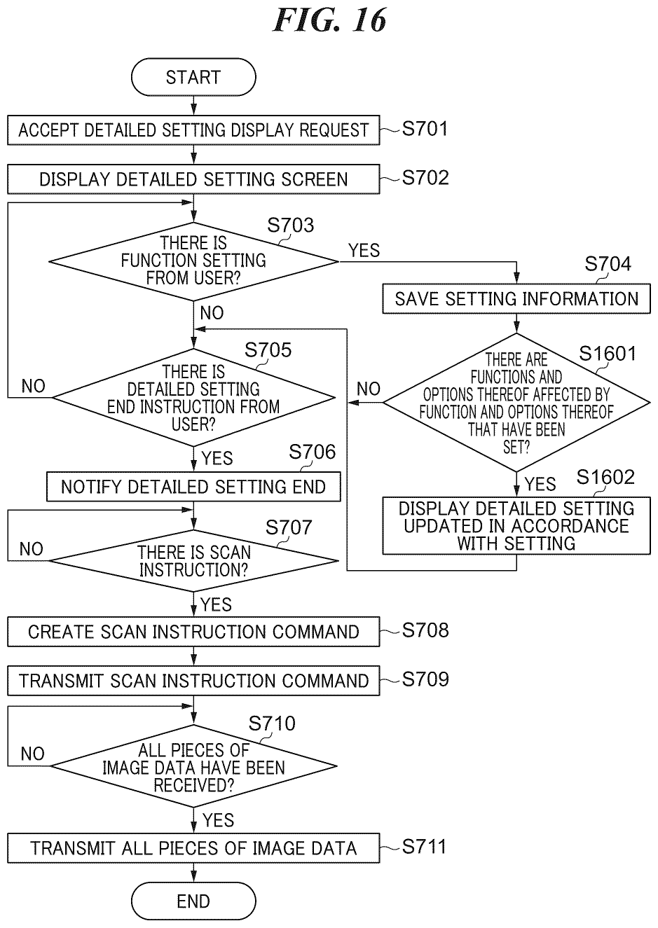

FIG. 16 is a flowchart that shows a processing executed by the extended application. As shown in FIG. 16, a step S1601 is executed between the step S704 and the step S705. Depending on a result of the determination in the step S1601, a step S1602 may be executed. In the step S1601 after the step S704 is executed, the scan setting screen extending unit 205 of the extended application 204 determines whether or not there are functions (and options thereof) that are affected by the function having been set (and options thereof). As the result of the determination in the step S1601, in the case of being determined that there are functions (and options thereof) that are affected by the function having been set (and options thereof), the processing proceeds to the step S1602. On the other hand, as the result of the determination in the step S1601, in the case of being determined that there are no functions (and options thereof) that are affected by the function having been set (and options thereof), the processing proceeds to the step S705.

In the step S1602, the scan setting screen extending unit 205 displays, on the display unit 119, a detailed setting screen 300C3 shown in FIG. 15B or a detailed setting screen 300C4 shown in FIG. 15C. As shown in FIG. 15B, for example, in the case where “document platen” has been set as the reading destination by using the control 305, “A4H”, “A3”, “B4”, “LTR”, and “LGL” are displayed in a list 1505 in accordance with the reading size on the document platen. As shown in FIG. 15C, for example, in the case where “feeder” has been set as the reading destination by using the control 305, “A4H”, “B4”, and “LTR” are displayed in a list 1507 in accordance with the reading size on the feeder. After the step S1602 is executed, the processing proceeds to the step S705.

As described above, when creating the scan function information 203, it is possible to change the scan function information 203 in combination with other capability information, and when the user performs the function setting, it is possible to change the detailed setting screen in combination with other functions.

### Fourth Embodiment

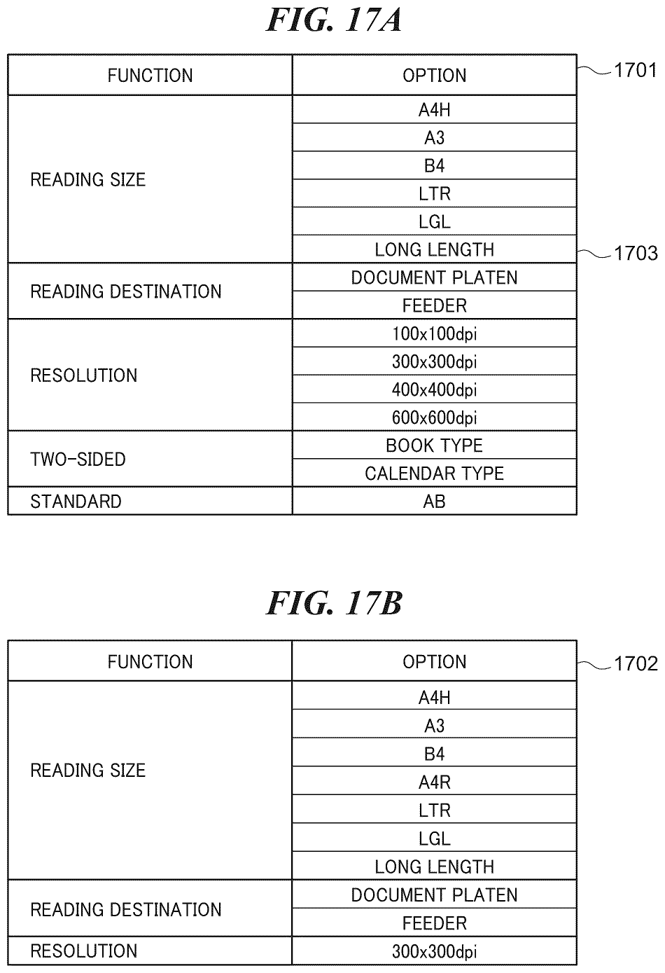

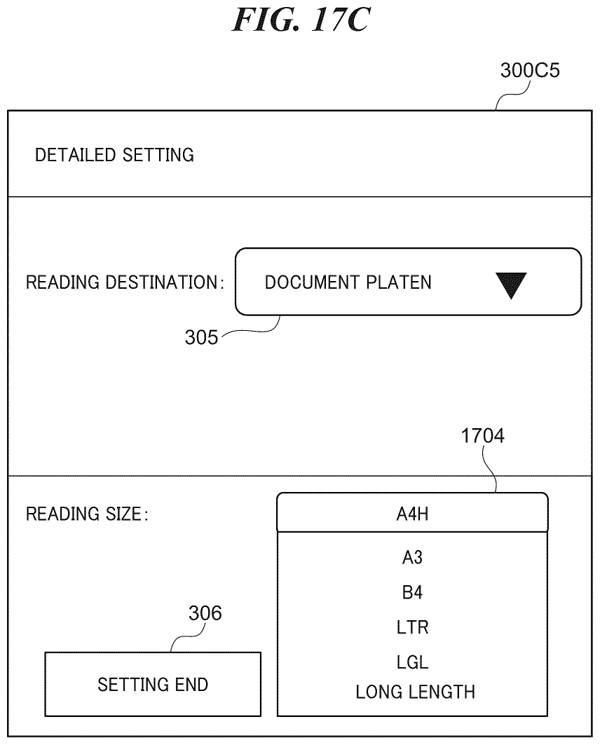

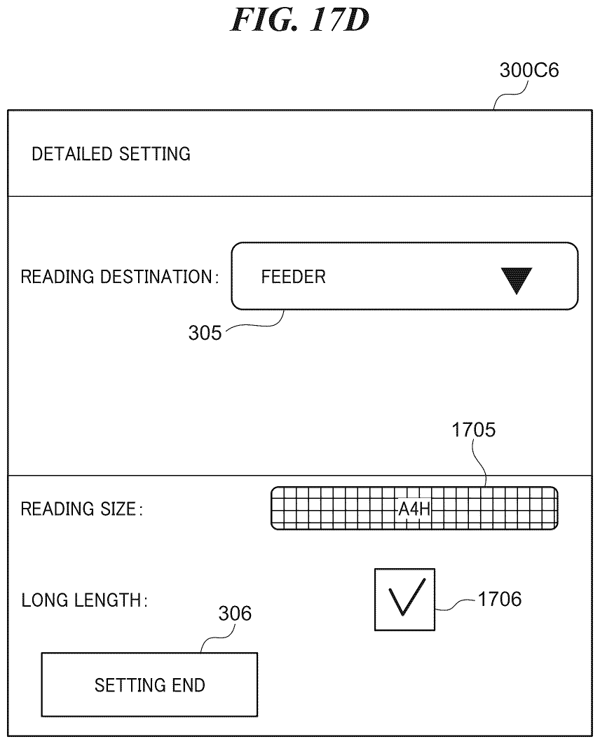

Hereinafter, a fourth embodiment of the present invention will be described with reference to FIGS. 17A to 19C. The differences from the embodiments described above will be mainly described, and descriptions of similar matters will be omitted. FIGS. 17A, 17B, 17C, and 17D are diagrams relating to the scan information in the fourth embodiment. A table 1701 shown in FIG. 17A shows an example of a list of the capability information that has been obtained from the scan apparatus 102. As shown in the table 1701, it is possible from the scan apparatus 102 to obtain information 1703. The information 1703 is information indicating that a long length is possible as the reading size. It should be noted that the information 1703 may be displayed as a reading size that is separate from the reading sizes that include “A4H”, “A3”, “B4”, “LTR”, and “LGL”. A table 1702 shown in FIG. 17B includes all scan functions that can be executed by the extended application 204 (all scan functions that can be supported by the extended application 204) and their setting values, and indicates that the long length scanning is also executable.

A detailed setting screen 300C5 shown in FIG. 17C and a detailed setting screen 300C6 shown in FIG. 17D are each in a state where the long length setting is possible. On the detailed setting screen 300C5, a list 1704 includes the reading size “long length”. The detailed setting screen 300C6 includes a control 1705 that enables “A4H”, “A3”, “B34”, “LTR”, and “LGL” as the reading size, and a check box 1706 that enables the long length setting as the reading size. In the case where the check box 1706 is checked and the long length setting has been set as the reading size, the control 1705 is displayed, for example, grayed out. As a result, an operation with respect to the control 1705 is prohibited. In this way, the detailed setting screen 300C6 includes two options, with respect to which, a selection operation can be performed (the control 1705 and the check box 1706). In this case, when a selection operation with respect to one of the two options (the check box 1706) is performed, a selection operation with respect to the other option (the control 1705) is prohibited. It should be noted that the number of the options included in the detailed setting screen 300C6 is not limited to two, and may be, for example, three or more. In addition, in the case where the long length reading on the document platen is not possible, when “document platen” has been selected by using the control 305, “long length” may be deleted from the list 1704 or the check box 1706 may be deleted.

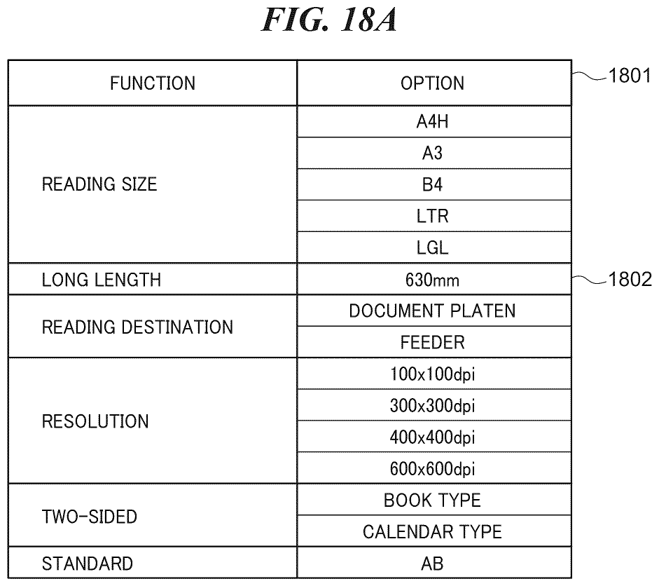

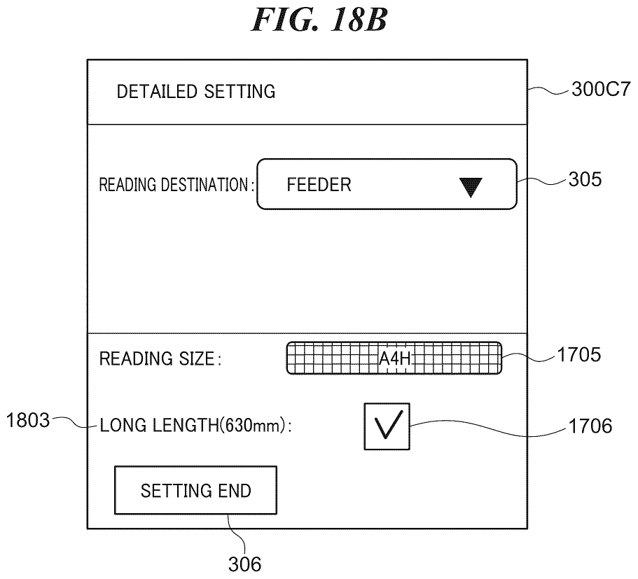

FIGS. 18A and 18B are diagrams relating to the scan information (a first modification). A table 1801 shown in FIG. 18A shows an example of a list of the capability information that has been obtained from the scan apparatus 102. As shown in the table 1801, it is possible from the scan apparatus 102 to obtain information 1802. The information 1802 is information that is separate from the reading sizes that include “A4H”, “A3”, “B4”, “LTR”, and “LGL”, and indicates the function “long length” and its option “630 mm”. “630 mm” is the maximum reading size of the document in a sub-scanning direction. On a detailed setting screen 300C7 shown in FIG. 18B, a comment 1803 has been arranged adjacent to the check box 1706. The comment 1803 indicates that the maximum reading size of the document in the sub-scanning direction is “630 mm”. As a result, the user is able to understand the maximum reading size of the document in the sub-scanning direction.

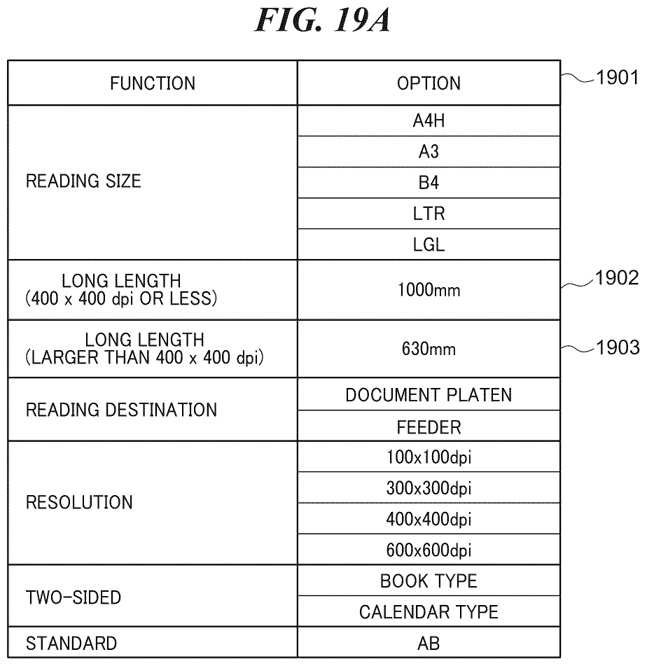

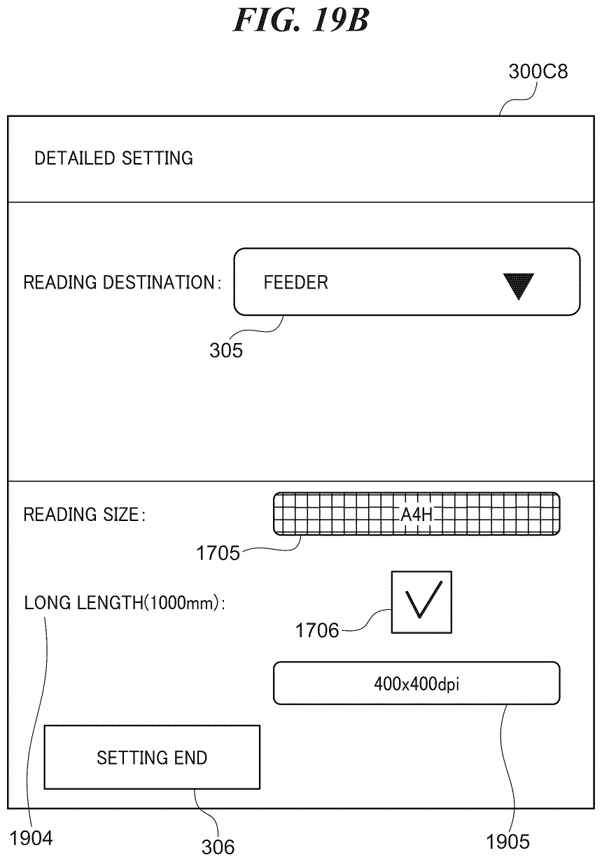

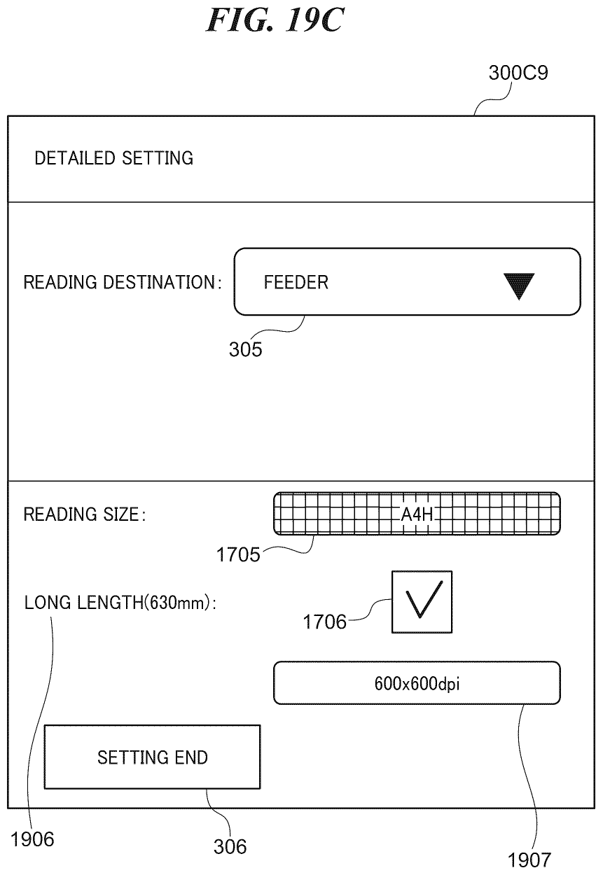

FIGS. 19A, 19B, and 19C are diagrams relating to the scan information (a second modification). A table 1901 shown in FIG. 19A shows an example of a list of the capability information that has been obtained from the scan apparatus 102. As shown in the table 1901, it is possible from the scan apparatus 102 to obtain information 1902 and information 1903. The information 1902 is information indicating that the maximum reading size of the document is “1000 mm” in the case where the resolution is “400×400 dpi or less”. The information 1903 is information indicating that the maximum reading size of the document is “630 mm” in the case where the resolution is “larger than 400×400 dpi”. A detailed setting screen 300C8 shown in FIG. 19B includes a comment 1904 and a control 1905. In the case where the user has inputted into the control 1905 that the resolution is “400×400 dpi”, the comment 1904 displays that the maximum reading size of the document is “1000 mm”. As a result, the user is able to understand the maximum reading size of the document in the case where the resolution is “400×400 dpi”. A detailed setting screen 300C9 shown in FIG. 19C includes a comment 1906 and a control 1907. In the case where the user has inputted into the control 1907 that the resolution is “600×600 dpi”, the comment 1906 displays that the maximum reading size of the document is “630 mm”. As a result, the user is able to understand the maximum reading size of the document in the case where the resolution is “600×600 dpi”. In this way, the maximum reading size is changed in accordance with the performance (the capability information) such as the resolution or the like in the scan apparatus 102.

### Fifth Embodiment

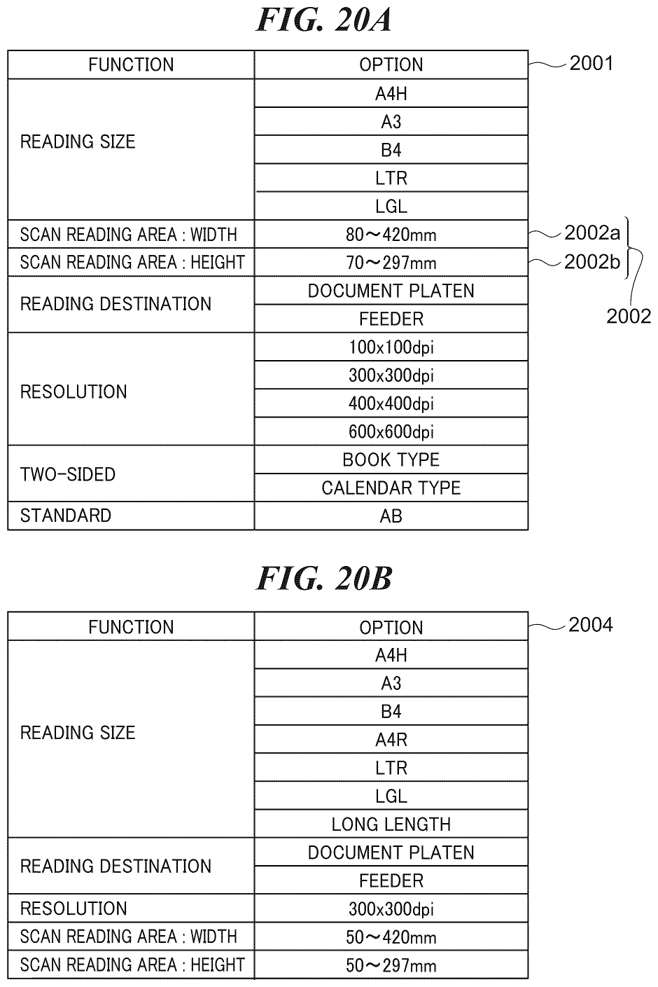

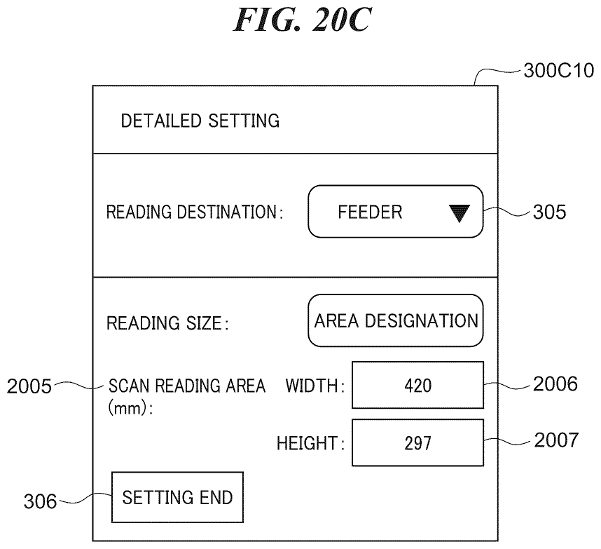

Hereinafter, a fifth embodiment of the present invention will be described with reference to FIGS. 20A to 22. The differences from the embodiments described above will be mainly described, and descriptions of similar matters will be omitted. FIGS. 20A, 20B, and 20C are diagrams relating to the scan information in the fifth embodiment. A table 2001 shown in FIG. 20A shows an example of a list of the capability information that has been obtained from the scan apparatus 102. As shown in the table 2001, it is possible from the scan apparatus 102 to obtain information 2002. The information 2002 is information about a scan reading area (a reading range), which is one of the scanning conditions. The information 2002 includes width direction information 2002a and height direction information (total length direction information) 2002b. The width direction information 2002a indicates that the width is capable of being set within a range of, for example, 80 to 420 mm. The height direction information 2002b indicates that the height is capable of being set within a range of, for example, 70 to 297 mm. A table 2004 shown in FIG. 20B includes all scan functions that can be executed by the extended application 204 (all scan functions that can be supported by the extended application 204) and their setting values, and indicates that setting of the scan reading area is also executable.

A detailed setting screen 300C10 shown in FIG. 20C is in a state where the scan reading area setting is possible. The detailed setting screen 300C10 includes a comment 2005, a control 2006, and a control 2007. The comment 2005 displays that the scan reading area setting is capable of being performed in mm units. It is possible to input, into the control 2006, an arbitrary numerical value within the numerical value range indicated by the width direction information 2002a, as the width of the scan reading area. It is possible to input, into the control 2007, an arbitrary numerical value within the numerical value range indicated by the height direction information 2002b, as the height of the scan reading area. In this way, by using the control 2006 and the control 2007, it is possible to change the scan reading area as appropriate. It should be noted that the maximum value or the minimum value, which can be inputted, may be inputted into the control 2006 and the control 2007 in advance as an initial value. The setting information of the scan reading area may be a numerical value converted into pixels.

As shown in the table 2001, as the scan reading area, it is readable at the width of 80 to 420 mm and the height of 70 to 297 mm. On the other hand, depending on the extended application 204, for example, there is a case where a scan reading area broader than (wider than) the scan reading area shown in table 2001 is capable of being set. In the fifth embodiment, for example, it is assumed that the extended application 204 is capable of reading a scan reading area having the width of 50 to 420 mm and the height of 50 to 297 mm. In this case, when the extended application 204 includes a unit that performs a reading size cutout processing, it is possible to add, to the scan function information 203, the size of the scan reading area according to the extended application 204. The image data editing unit 207 is able to perform the cutout processing with respect to the scanned image data from the scan apparatus 102 based on the size setting of the scan reading area that has been set by the user.

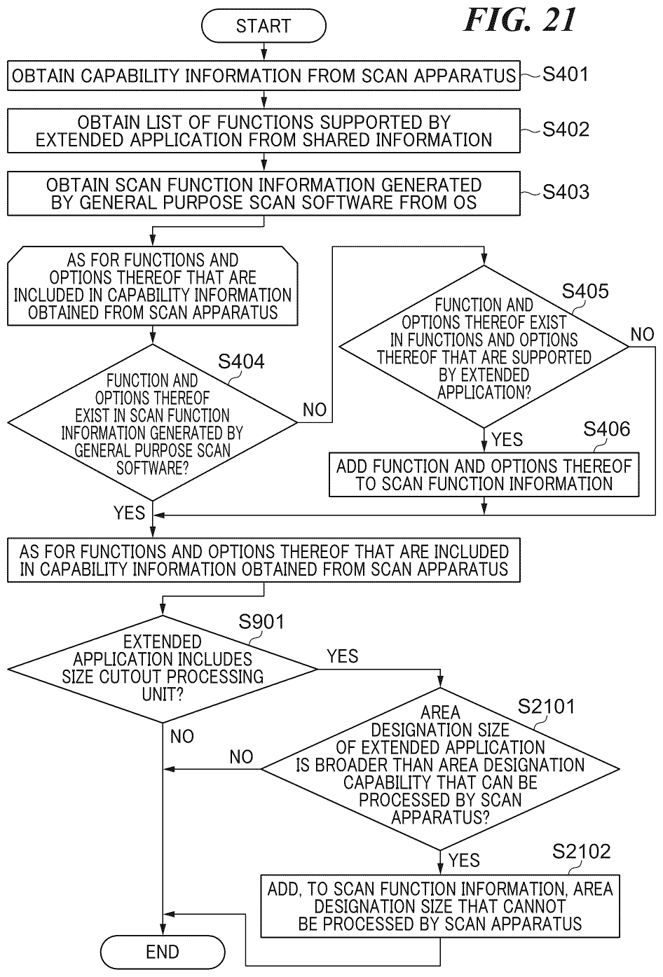

FIG. 21 is a flowchart that shows a processing in which the scan function extending unit edits the scan function information. In the flowchart shown in FIG. 21, similar to the flowchart shown in FIG. 9, after the steps S401 to S406 are executed, the processing proceeds to the step S901. As described above, the scan apparatus 102 supports the scan reading area with the width of 80 to 420 mm and the height of 70 to 297 mm. Therefore, the scan reading area with the width of 80 to 420 mm and the height of 70 to 297 mm has been added to the scan function information 203 after the repeated processing of the steps S404 to S406 is completed. As the result of the determination in the step S901, in the case of being determined that the extended application 204 includes the size cutout processing unit, the processing proceeds to a step S2101. In the step S2101, the scan function extending unit 206 determines whether or not the scan reading area that is capable of being set by the extended application 204 is broader than the scan reading area that is capable of being set by the scan apparatus 102. As a result of the determination in the step S2101, in the case of being determined that the scan reading area that is capable of being set by the extended application 204 is broader than the scan reading area that is capable of being set by the scan apparatus 102, the processing proceeds to a step S2102. On the other hand, as the result of the determination in the step S2101, in the case of being determined that the scan reading area that is capable of being set by the extended application 204 is not broader than the scan reading area that is capable of being set by the scan apparatus 102, the processing ends. As described above, in the fifth embodiment, since the scan reading area that is capable of being set by the extended application 204 is broader than the scan reading area that is capable of being set by the scan apparatus 102, after the step S2101 is executed, the processing proceeds to the step S2102.

In the step S2102, the scan function extending unit 206 adds the scan reading area having the width of 50 to 420 mm and the height of 50 to 297 mm. As a result, even in the case where the scan reading area that is capable of being set by the extended application 204 is broader than the scan reading area that is capable of being set by the scan apparatus 102, it becomes settable. After the step S2102 is executed, the processing ends.

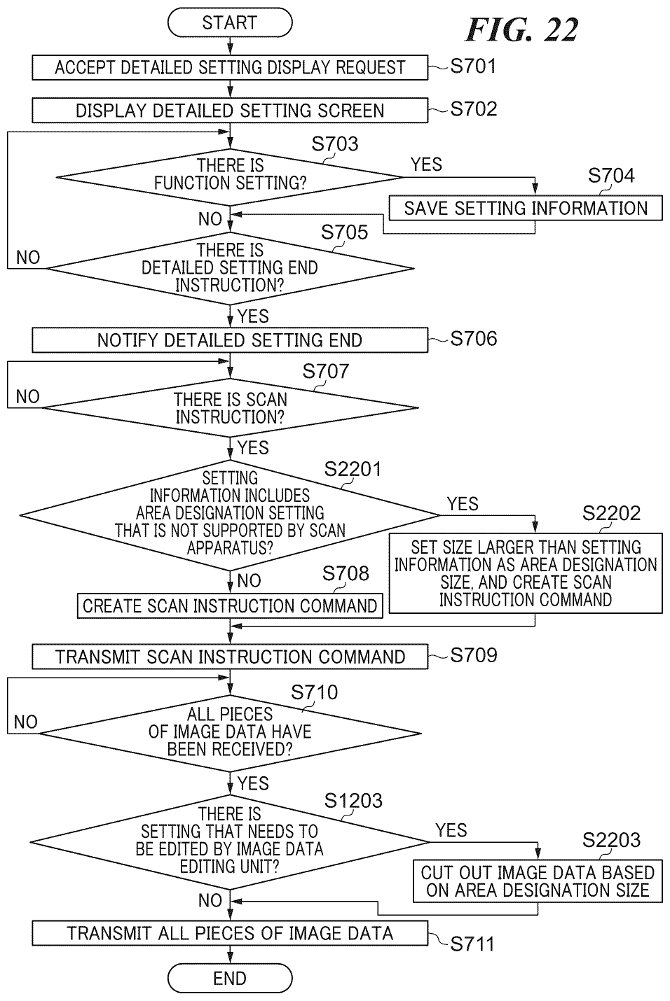

FIG. 22 is a flowchart that shows a processing executed by the extended application. The flowchart shown in FIG. 22 differs from the flowchart shown in FIG. 12 in that a step S2201 is executed instead of the step S1201, a step S2202 is executed instead of the step S1202, and a step S2203 is executed instead of the step S1204. In the step S2201 after the step S704 is executed, the extended application 204 obtains the capability information of the scan apparatus 102 from the shared information 208. The extended application 204 determines whether or not there is a scan reading area setting that cannot be executed (is not supported) by the scan apparatus 102 based on the capability information, etc. As a result of the determination in the step S2201, in the case of being determined that there is a scan reading area setting that cannot be executed by the scan apparatus 102, the processing proceeds to the step S2202. On the other hand, as the result of the determination in the step S2201, in the case of being determined that there is no scan reading area setting that cannot be executed by the scan apparatus 102, the processing proceeds to the step S708. It should be noted that in the fifth embodiment, since the width 50 mm, which cannot be read by the scan apparatus 102, has been set, the processing proceeds to the step S2202.

In the step S2202, the extended application 204 sets the minimum area setting that can be set by the scan apparatus 102 as the reading size, instead of the setting information, and creates a scan instruction command. In the fifth embodiment, the minimum area setting is set to the width of 80 mm. After the step S2202 is executed, the processing proceeds to the step S709.

In addition, as the result of the determination in the step S1203, in the case of being determined that there is a setting that needs to be edited by the image data editing unit 207, the processing proceeds to the step S2203. In the step S2203, the image data editing unit 207 performs a cutout processing with respect to the scanned image data based on the reading size setting that has been set in the step S703. After the step S2203 is executed, the processing proceeds to the step S711.

### Sixth Embodiment

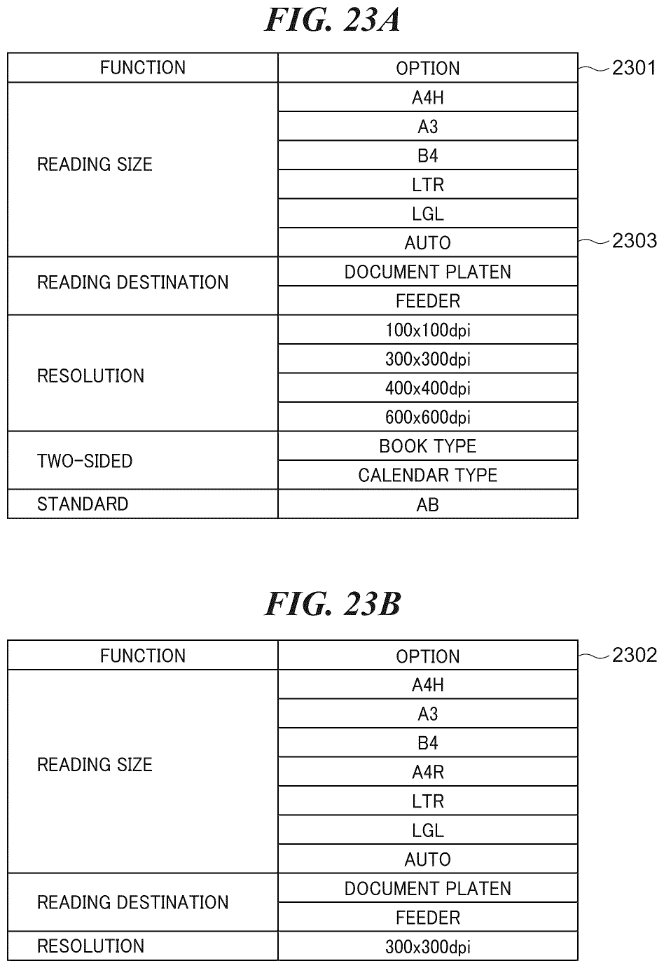

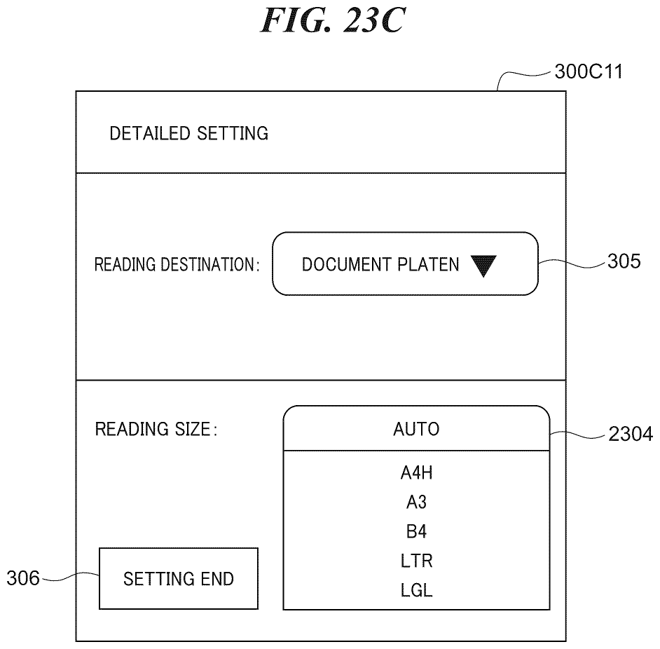

Hereinafter, a sixth embodiment of the present invention will be described with reference to FIGS. 23A, 23B, and 23C. The differences from the embodiments described above will be mainly described, and descriptions of similar matters will be omitted. FIGS. 23A, 23B, and 23C are diagrams relating to the scan information in the sixth embodiment. A table 2301 shown in FIG. 23A shows an example of a list of the capability information that has been obtained from the scan apparatus 102. As shown in the table 2301, it is possible from the scan apparatus 102 to obtain information 2303. The information 2303 is information about an automatic reading size as reading size information. A table 2302 shown in FIG. 23B includes all scan functions that can be executed by the extended application 204 (all scan functions that can be supported by the extended application 204) and their setting values, and indicates that setting of the automatic reading size is also executable. A detailed setting screen 300C11 shown in FIG. 23C is in a state where the automatic reading size setting is possible. On the detailed setting screen 300C11, the reading size “Auto (the automatic reading size setting)” is included in a list 2304. In the sixth embodiment, in the case where the scan apparatus 102 is capable of performing automatic size detecting and reading, it becomes possible to provide the user with a function that executes the automatic reading size.

### Seventh Embodiment

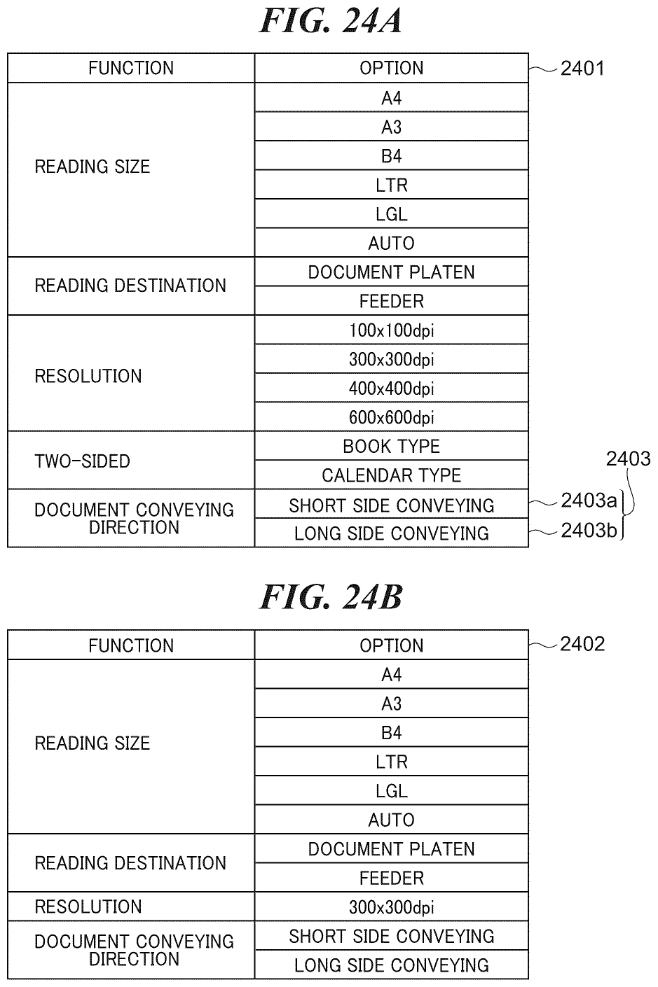

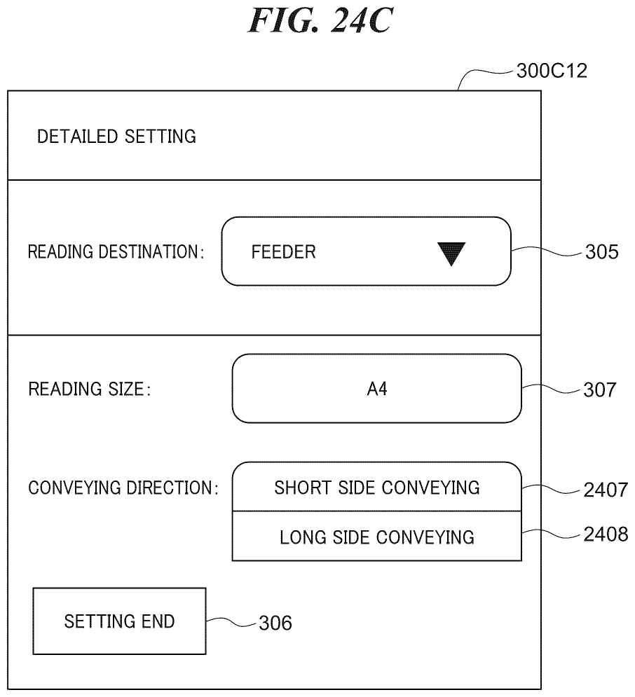

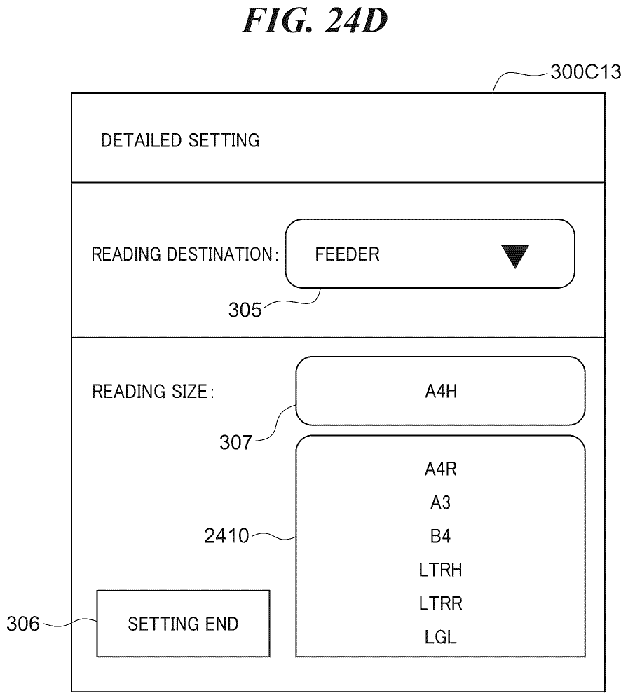

Hereinafter, a seventh embodiment of the present invention will be described with reference to FIGS. 24A, 24B, 24C, and 24D. The differences from the embodiments described above will be mainly described, and descriptions of similar matters will be omitted. FIGS. 24A, 24B, 24C, and 24D are diagrams relating to the scan information in the seventh embodiment. A table 2401 shown in FIG. 24A shows an example of a list of the capability information that has been obtained from the scan apparatus 102. As shown in the table 2401, it is possible from the scan apparatus 102 to obtain information 2403. The information 2403 is information about a scanning direction when reading a document, which is one of the scanning conditions. The scanning direction includes a main scanning direction, and the sub-scanning direction perpendicular to the main scanning direction. The main scanning direction coincides with a document reading direction in which the document is read. The sub-scanning direction coincides with a document conveying direction in which the document is conveyed. In addition, the information 2403 includes, as information about the document conveying direction, short side conveying information 2403a and long side conveying information 2403b. The short side conveying information 2403a is information indicating that the document is conveyed along a short side direction thereof. The long side conveying information 2403b is information indicating that the document is conveyed along a long side direction thereof. A table 2402 shown in FIG. 24B includes all scan functions that can be executed by the extended application 204 (all scan functions that can be supported by the extended application 204) and their setting values, and indicates that setting of the document conveying direction is also executable.

A detailed setting screen 300C12 shown in FIG. 24C is in a state where the document conveying direction setting is possible. The detailed setting screen 300C12 includes a control 2407 and a control 2408. By selecting the control 2407, it is possible to set the document conveying direction to the short side direction, and perform scanning suitable for the short side direction. By selecting the control 2408, it is possible to set the document conveying direction to the long side direction, and perform scanning suitable for the long side direction. Similar to the detailed setting screen 300C12, a detailed setting screen 300C13 shown in FIG. 24D is in the state where the document conveying direction setting is possible. By operating the control 307 on the detailed setting screen 300C13, a list 2410 is displayed. The list 2410 includes, as the reading size of the document, “A4H”, “A4R”, “A3”, “B4”, “LTR”, and “LGL”, and in FIG. 24D, “A4H” has been selected as an example. For example, for “A4”, it is possible to perform conveyance not only along the short side conveying direction but also along the long side conveying direction. Therefore, the list 2410 includes “A4H” indicating the long side conveying and “A4R” indicating the short side conveying. In this way, the detailed setting screen 300C13 shown in FIG. 24D is also in the state where the document conveying direction setting is possible. For example, in the case where “A4H” has been selected, “A4H” may be written as the reading size into the scan instruction command, or the reading size “A4” may be written into the scan instruction command and “long side conveying” may be written as the conveying direction into the scan instruction command.

In addition, depending on the scan apparatus 102, for example, for “A3”, there is a case where the short side conveying is possible but the long side conveying is not possible. In this case, on the detailed setting screen 300C12, the control 2408 may be displayed in a grayed-out state, or the control 2408 may be deleted once. In this way, prior to scanning by the scan apparatus 102, it is determined whether or not reading of the document by the scan apparatus 102 under the scanning conditions “A3” and “short side conveying” that have been accepted on the detailed setting screen 300C12 is possible (a determining step). In addition, as a result of the determination, in the case of being determined that reading of the document by the scan apparatus 102 under the scanning conditions “A3” and “short side conveying” that have been accepted on the detailed setting screen 300C12 is possible, it is possible to cause the scan apparatus 102 to read the document in accordance with “A3” and “short side conveying”. On the other hand, in the case where the scanning conditions “A3” and “long side conveying” have been set on the detailed setting screen 300C1, it is determined that reading of the document is not possible. Furthermore, by changing the scanning conditions “A3” and “long side conveying” to the scanning conditions “A3” and “short side conveying”, it is possible to cause the scan apparatus 102 to read the image of the document.

### Eighth Embodiment

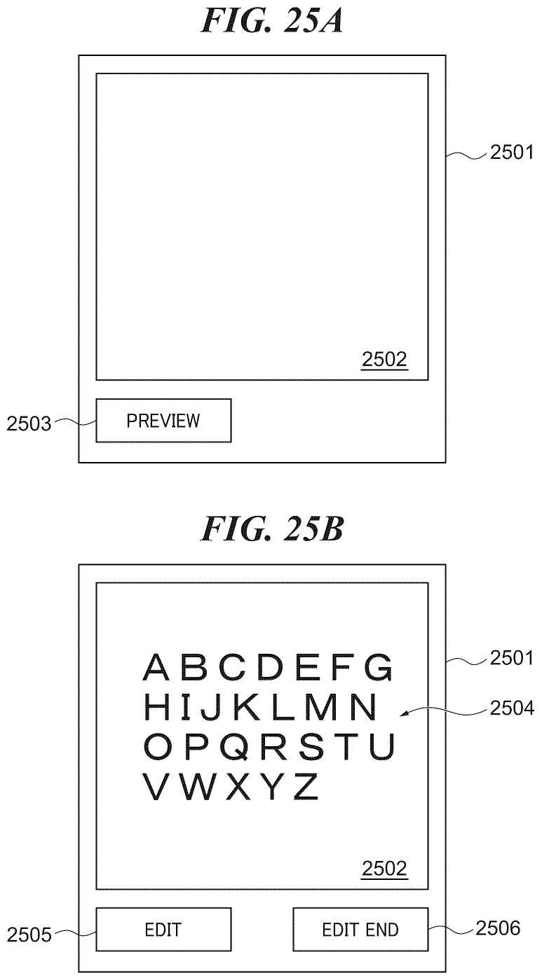

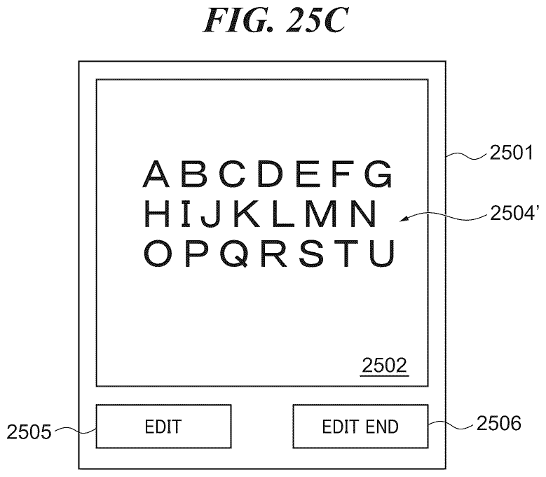

Hereinafter, an eighth embodiment of the present invention will be described with reference to FIGS. 25A, 25B, and 25C. The differences from the embodiments described above will be mainly described, and descriptions of similar matters will be omitted. FIGS. 25A, 25B, and 25C are diagrams that show examples of the screens displayed on the display unit of the scan system in the eighth embodiment. FIG. 25A shows a display screen 2501 that displays the result of reading of the document as a preview image. The display screen 2501 includes a display area 2502 for displaying the preview image, and an instruction button 2503 for instructing the display of the preview image on the display area 2502. Furthermore, by operating the instruction button 2503, the display screen 2501 becomes a state shown in FIG. 25B. As shown in FIG. 25B, a preview image 2504 is displayed on the display area 2502 of the display screen 2501. In addition, the display screen 2501 in the state shown in FIG. 25B includes an edit button 2505 for editing the preview image 2504 and an instruction button 2506 for instructing to end editing of the preview image 2504. Furthermore, by operating the edit button 2505, it is possible to edit the preview image 2504. This editing is performed by using, for example, the pointing device 117 and the keyboard 118.

For example, in the case where the preview image 2504 is a character string “ABC . . . XYZ”, the character string has been edited to a character string “ABC . . . STU”. As a result, the editing content of the preview image 2504 is reflected, and as shown in FIG. 25C, an edited preview image 2504′ is displayed on the display area 2502. As a result, it is possible to confirm the edited preview image 2504′, and it is also possible to print the preview image 2504′.

In each of the embodiments described above, the example has been described in which the image data that has been generated by reading the document with the scan apparatus (the scanner) 102 is transmitted to the host computer 101. However, the present invention is not limited to this. For example, the setting of the reading size and the reading processing that is performed by the scan apparatus 102, which have been described above, may be applied to an example in which the image data that has been generated by reading the document with the scan apparatus (the scanner) 102 is transmitted by fax via a modem (not shown). In the case of being applied to fax transmission, a fax destination may also be accepted on the screen of FIG. 3C, and the extended application 204 may include the destination number in the scan command and issue a fax instruction to the scan apparatus 102. When the scan apparatus 102 receives the fax instruction, the scan apparatus 102 transmits the image data by fax to the received destination number without transmitting the image data to the host computer 101 in the step S617.

On the detailed setting screen, the scanning conditions such as the reading size, the scan reading area, the scanning direction when reading an image, etc. can be accepted separately, but are not limited to this. The detailed setting screen only needs to be able to accept at least one of these settings, and may be able to accept a plurality of settings.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-042612, filed on Mar. 18, 2024, which is hereby incorporated by reference herein in its entirety.

What is claimed is:

1. A non-transitory computer-readable storage medium storing an application program that supports a software program capable of being commonly used for image processing apparatuses from a plurality of manufacturers for causing a computer to execute:
a display control step of causing to display a setting acceptance screen that accepts a setting of a reading condition for an image to be read by the image processing apparatus; and
a reading step of causing the image processing apparatus to read the image based on the reading condition that has been accepted on the setting acceptance screen.

2. The non-transitory computer-readable storage medium according to claim 1, wherein
the setting acceptance screen accepts, as the reading condition, at least one setting of a reading size of the image, a reading range of the image, and a scanning direction when reading the image.

3. The non-transitory computer-readable storage medium according to claim 2, wherein
a maximum reading size of the image is displayed on the setting acceptance screen.

4. The non-transitory computer-readable storage medium according to claim 3, wherein
on the setting acceptance screen, the maximum reading size of the image is changed in accordance with the image processing apparatus.

5. The non-transitory computer-readable storage medium according to claim 2, wherein
the setting acceptance screen is configured to be able to input the reading range of the image with an arbitrary value.

6. The non-transitory computer-readable storage medium according to claim 1, wherein
the setting acceptance screen includes a plurality of options from which the reading condition is capable of being selected.

7. The non-transitory computer-readable storage medium according to claim 6, wherein
the setting acceptance screen is configured to be able to prohibit selection of at least one option among the plurality of options.

8. The non-transitory computer-readable storage medium according to claim 1, wherein
the setting acceptance screen includes a decision operation section that causes to decide end of the setting of the reading condition.

9. The non-transitory computer-readable storage medium according to claim 8, wherein
the application program causes the computer to, in a case where the decision operation section has been operated, execute the reading step.

10. The non-transitory computer-readable storage medium according to claim 1, wherein
the display control step is capable of switching whether or not to display the setting acceptance screen in accordance with the image processing apparatus.

11. The non-transitory computer-readable storage medium according to claim 1, wherein
the application program causes the computer to execute a determining step of, prior to reading in the reading step, determining whether or not reading of the image by the image processing apparatus is possible based on the reading condition that has been accepted on the setting acceptance screen.

12. The non-transitory computer-readable storage medium according to claim 11, wherein
in the reading step, as a result of the determination in the determining step, in a case of being determined that reading of the image is possible, the image processing apparatus is caused to read the image based on the reading condition, and in a case of being determined that reading of the image is not possible, the reading condition is changed and the image processing apparatus is caused to read the image.

13. The non-transitory computer-readable storage medium according to claim 1, wherein
the application program causes the computer to execute a preview image display step of causing to display a result of reading the image in the reading step as a preview image.

14. The non-transitory computer-readable storage medium according to claim 13, wherein
the preview image is configured to be editable, and
an editing content of the preview image is capable of being reflected in the result of reading the image in the reading step.

15. A control method for performing control that supports a software program capable of being commonly used for image processing apparatuses from a plurality of manufacturers,
the control method comprising:
a display control step of causing to display a setting acceptance screen that accepts a setting of a reading condition for an image to be read by the image processing apparatus; and
a reading step of causing the image processing apparatus to read the image based on the reading condition that has been accepted on the setting acceptance screen.

16. An information processing apparatus that is communicably connected to image processing apparatuses from a plurality of manufacturers and is capable of processing information to and from the image processing apparatuses,
the information processing apparatus comprising:
a software program capable of being commonly used for the image processing apparatuses from the plurality of manufacturers; and
an application program that supports the software program, and
wherein the application program causes a computer to execute:
a display control step of causing to display a setting acceptance screen that accepts a setting of a reading condition for an image to be read by the image processing apparatus; and
a reading step of causing the image processing apparatus to read the image based on the reading condition that has been accepted on the setting acceptance screen.
